(19) United States
(12) Patent Application Publication
(10) Pub. No.: US 2026/0359560 A1
(43) Pub. Date: Nov. 12, 2026

(54) AUTOMATED SUMMARY GENERATION OF CONTENT

(71) Applicant: Salesforce, Inc., San Francisco, CA (US)

(72) Inventors: Shaunak Shatmanyu, Fremont, CA (US); Vishal Surendrabhai Shah, Redmond, WA (US); Aditi Deshpande, San Carlos, CA (US); Melissa Hoang, Irvine, CA (US); Sameer Abhinkar, Cupertino, CA (US); Keyurkumar Rajendrabhai Patel, Fremont, CA (US); Janice Johnson, Sunnyvale, CA (US); Xiangbo Mao, Vancouver (CA)

(21) Appl. No.: 19/201,402

(22) Filed: May 7, 2025

(51) Int. Cl. G06F 40/186; G06Q 30/015

(52) U.S. Cl. CPC G06F 40/186; G06Q 30/015

(57) ABSTRACT

Communications may occur within multiple different communication channels (e.g., email messages, chat messages, text messages, audio calls, messages exchanged via a website) and be stored within sources associated with the communication channels. A request to summarize the communications may be received via a user interface. One or more models may extract such interaction data, aggregate the interaction data, and process the interaction data to generate a summarization of the interaction data. The summarization may be presented via the user interface for subsequent review and approval. The summarization may be stored in association with a case associated with the communications.

### TECHNICAL FIELD

Communication platforms are becoming increasingly more popular for organizations and users to facilitate work-related communications. Users of such communication platforms can communicate with other users via virtual spaces, such as channels, direct messages, and/or other types of virtual spaces. In some examples, a user of a communication platform may interact with an agent (or service representative) of the communication platform, and exchange information to the agent, using multiple different communication channels, including the virtual spaces referenced above, as well as email messages, text messages, chat messages, video/voice calls, etc. Manually reviewing various portions of this information may cause the agent, or a different user/agent, to have an incomplete view of the issue(s) being discussed between the user and the agent. Moreover, reviewing, synthesizing, and summarizing such information from multiple different sources would require significant computational resources and would be time consuming.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different figures indicates similar or identical components or features. The figures are not drawn to scale.

FIG. 1 illustrates an example system for performing techniques described herein.

FIG. 2 illustrates an example architecture utilized to for the automatic summarization of content utilizing machine learning and/or generative artificial intelligence (AI).

FIG. 3 illustrates an example user interface associated with a communication platform displaying options to provide summarization for content.

FIG. 4 illustrates an example user interface associated with a communication platform displaying an option to summarize content to generate a case summarization.

FIG. 5 illustrates an example user interface associated with a communication platform displaying a proposed summarization of content, including an ability to save the summarization.

FIG. 6 illustrates an example user interface associated with a communication platform displaying a saved summarization of content, including an ability to share the summarization.

FIG. 7 illustrates an example user interface associated with a communication platform displaying a published summarization of content, including an ability to share an update relating to the summarization.

FIG. 8 illustrates an example user interface associated with a communication platform displaying prompt templates that may be utilized for the automatic summarization of content.

FIG. 9 illustrates an example user interface associated with a communication platform displaying a prompt template workspace associated with a prompt template that may be utilized for the automatic summarization of content.

FIG. 10 is a flow diagram illustrating an example process of utilizing machine learning and/or generative AI for the automatic summarization of content.

### DETAILED DESCRIPTION

As discussed above and with respect to content that is maintained in a plurality of different communication channels (e.g., communication-based platforms, chat message systems, voicemail systems, email systems, etc.), conventional techniques for identifying, accessing, and aggregating the content may be ineffective, inefficient, disruptive to the user experience, and/or lead to suboptimal results. For example, provided that a user or agent is attempting to identify content that is relevant to a particular issue, case, project, topic, event, etc., the user/agent is unable to access all of this content in a single location, and is instead required to visit each of these different communication channel sources to identify and access the content. Not only does the user/agent need to access such sources, the user/agent also would need to manually review the information included in each source in order to have an overview or summary of the content. Furthermore, a user/agent performing searches within the different communication channel sources may not yield relevant content. Even if such content is identified in the different sources, the user/agent then needs to aggregate the content, potentially manually input the content into a single space/location, and/or manually generate an overview or summary of the content.

As a hypothetical example, assume that a customer support agent handles numerous cases associated with different users utilizing different, and potentially multiple, communication channels. For instance, an agent may interact with a user regarding a potential problem or issue that the user is experiencing. Such communications may occur via email messages, chat messages, telephone calls, virtual spaces (e.g., communication channels) of a group-based communication platform, website chats, and so on. As a result, although information exchanged between the agent and the user may be stored for subsequent access, the information may be stored in different formats (e.g., stored email/chat messages, voice transcripts, etc.) and at different locations (e.g., email inboxes, databases, etc.). If the agent, the user, or a different agent/user would like to review or get up to date on what has been discussed thus far between the agent and the user, they would need to access each communication channel source in which discussions have taken place. The manual process of reviewing the history of interactions between the user and the agent (i.e., the case history) would be time-consuming, inefficient, and would likely require significant computational resources to both access the different sources and review the content that is relevant to the case. The agent/user would need to navigate to each source and conduct multiple different searches to obtain the information that they desire, consuming computational resources along the way.

In addition, users and agents have to pivot between multiple applications, websites, tabs, and other data sources (e.g., notes, presentations, emails, chats, voice transcripts, etc.) to search for and identify the information they are looking for when handling a service call, or preparing for a meeting, for example. The users typically have to “swivel chair” between all of these data sources and manually synthesize the data from the multiple data sources in order to have an understanding of a case/issue, analyze and create action items, determine processes to perform, generate a summarization of the case/issue, and so on. Such a process takes a significant amount of time and expends valuable computing resources needed to navigate and toggle between these different sources. Moreover, it is difficult to determine contextual data relating to interactions, conversations, information exchange, etc., between users and/or agents. Relevant information or content may be accessible and available to a user/agent, but identifying where such information is found, determining which of the information is relevant, and summarizing the information can be incredibly difficult and challenging. Chat-based interfaces are commonly utilized to search for and identify data, but such chat-based interfaces are limited since they typically only provide specific answers to specific user questions in a text-based format. For instance, a broader context with respect to the user's issue or problem may be better served in a visual format, such as a user interface-like format so that the agent can fully comprehend a specific problem or issue being experienced by a user.

To address these and other technical problems and inefficiencies, techniques for automatically generating summarizations of content utilizing one or more generative AI models and/or techniques (e.g., large language models (LLMs), machine-learning (ML) models, etc.) are discussed herein. A generative AI-enabled system may intelligently retrieve relevant data from various sources (both internal and external to the user/agent or the organization of the user/agent) and may provide a summarization of the data in real-time and in a matter of seconds, as opposed to hours or days. Based on interactions between a user and an agent using one or more communication channels, which may relate to an issue or problem being experienced by the user, the system may retrieve information/data relevant to the issue/problem from the sources in which the interactions occurred. For instance, such data may be extracted from email messages or chat messages exchanged between the user and the agent, audio transcripts or transcripts of telephone/audio calls conducted between the user and the agent, textual messages/exchanges via a portal, virtual space, or website, and so on. In particular, one or more generative AI models may be utilized to identify data relevant to the problem/issue experienced by the user from a plurality of different sources (e.g., communication-based platforms, email-based systems/accounts, chat-based systems/accounts, databases, websites, transcripts from audio calls, etc.), aggregate that data, and then process the data to automatically provide a summarization of such data. The summarization may be in a textual format that provides an overview of the issue/problem, as well as interactions between the user/agent and potential resolutions to the issue/problem. In other embodiments, or in addition, the summarization may also be depicted in a visual format using one or more diagrams, timelines, charts, etc. As a result, the agent and/or the user can view a summary of interactions between the user and the agent to date, which would be especially helpful if time has passed since the interactions. In some instances, if the agent is unavailable, cannot be reached, and/or does not have time, a new agent may assist the user with the problem/issue. The new agent may review the summarization prior to assisting the user and/or cause the system to automatically generate the summarization for the new agent's review.

Initially, a user and an agent (or another user) may interact with one another regarding a problem/issue that the user is experiencing, and such interactions may occur via different communication channel sources (e.g., email, chat, telephone calls, exchange via a website or portal, etc.) and at different times/days. Instead of the user, the agent, and/or a different user/agent needing to access those sources to obtain data/information relevant to the problem/issue, a summarization of the data may be requested via a user interface. In response, the system may retrieve and aggregate responsive data (e.g., structured data, unstructured data) from the various sources in which interactions between the user and the agent occurred. The system may then use one or more generative AI models to automatically generate a summarization of the problem/issue, the interactions between the user/agent, and/or potential causes/solutions associated with the problem/issue. The summarization may be presented to the user/agent via the same user interface in which the summarization was requested (or a different user interface). As a result, with respect to the problem/issue experienced by the user, the user and/or the agent need only access the summarization to have an overview and a general understanding of the problem/issue, as opposed to the user/agent having to spend the time and computational resources attempting to find such information from many different sources.

In some embodiments, the size, shape, configuration, layout, etc. of the summarization may be modified based on preferences of the user and/or agent, the specific problem/issue in question, the different sources utilized by the user/agent to discuss the problem/issue, or for any other reason. Moreover, the amount of information or content included within the summarization may vary such that a robust amount of the most relevant information may be displayed. On the other hand, a rather brief summary or condensed version of that same information may be included in the summarization. The user interface that is utilized to generate and/or display the summarization may include user selectable controls that allows a user or an agent to select or modify the manner in which the summarization is displayed. As discussed throughout this disclosure, the techniques may improve the user experience by enabling users/agents to quickly and efficiently receive an overview and summary of a specific problem/issue that was previously discussed by the user/agents, even though the interactions may have occurred via different communication channel sources.

Therefore, the system and processes described herein may utilize one or more generative AI models to aggregate data relating to customer support cases for a user that are handled by one or more agents. Interactions between the users and the agents may occur via various types of communication channels, such as email messages, chat messages, telephone calls, websites, and so on. The information exchanged in the interactions may include text, audio, documents, visual diagrams, and any other types of medium that allows the agent to assist the user with their problem or issue. Summarizations of the customer support cases may be requested via a user interface, by either the user or the agent, and the summarizations may be automatically generated using the generative AI model(s). The summarizations may include a concise case summaries that are generated by processing structured and unstructured data associated with the user/agent interactions. Customer support agents may handle numerous cases at a time, which may make it difficult to be constantly updated and aware of the status of each case at any given point in time. The manual process of reviewing the history of a case is time-consuming, inefficient, and utilizes a significant amount of computing resources. This may increase the average handle time (AHT) for each case (or each interaction with a user) and after-call work (ACW) that is to occur after the interaction between the user/agent takes place. Existing summarization techniques lack adaptability and scalability, and fail to capture contextual highlights from conversations between users and agents.

The generative AI model(s) may generate concise, structured summaries of customer service cases by processing case-related interactions, extracting relevant information, and automatically generating the summarizations, which may include a summary section that provides a summary of the case, an issue section that identifies the issue/problem being experienced by the user, and a resolution section that identifies how the issue/problem is going to be, or has been, resolved. If no resolution is to occur, the resolution section may include that information.

Initially, parameters and/or settings associated with generating summarizations may be determined and/or adjusted. Such parameters/settings may include the type of summarization, the length/complexity of the summarizations, an indicated of users authorized to generate the summarizations, and so on. In some embodiments, an administrator may configure the summarization settings/parameters, potentially via an administrator dashboard. Input fields utilized for summarization may also be customized, and various controls may be presented that indicate whether AI-generated case summaries are enabled or disabled. In some embodiments, an agent may initiate summarization for a particular case via a user interface. The agent may be one who previously worked on the case with a user, or the agent may be someone who has no previous experience with the case. Upon the summarization being initiated, the system may fetch or retrieve, possibly using one or more application programming interfaces (APIs), relevant case-related information from the different sources in which interactions between a user and an agent took place. In some embodiments, an API (e.g., a conversation service connect API) may fetch conversation transcripts corresponding to audio calls between the user and the agent. The retrieved/fetched data/information may then be processed by the generative AI model(s). For example, a prompt runtime service may send structured data to a gateway (e.g., LLM gateway) of the generative AI model(s) for summarization. The generative AI model(s) may then generate the summarization and render the summarization within a user interface that is accessible to the agent. Via the user interface, the agent can review, edit, and approve/confirm the summarization prior to saving it for subsequent access. An API may track and log interactions (e.g., user or agent interactions) with the AI-generated summarizations. Once saved, the summarization may be stored in an accessible format in various storage locations, such as a case history, file, and/or page/site associated with the case.

For the purposes of this disclosure, the communication platform that generates the summarizations can be a group-based communication platform, a channel-based messaging platform, a sales-based platform, and/or any other platform for facilitating communication between and among users. Users can use a variety of devices (or “user devices”) to access the communication platform. Such devices may include any suitable type of computing device, e.g., portable, semi-portable, semi-stationary, or stationary. Some examples of a user device can include a tablet computing device, a smart phone, a mobile communication device, a laptop, a netbook, a desktop computing device, a terminal computing device, a wearable computing device, an augmented reality device, an Internet of Things (IOT) device, or any other computing device capable of sending communications and performing the functions according to the techniques described herein.

The following detailed description of examples references the accompanying drawings that illustrate specific examples in which the techniques can be practiced. The examples are intended to describe aspects of the systems and methods in sufficient detail to enable those skilled in the art to practice the techniques discussed herein. Other examples can be utilized and changes can be made without departing from the scope of the disclosure. The following detailed description is, therefore, not to be taken in a limiting sense. The scope of the disclosure is defined only by the appended claims, along with the full scope of equivalents to which such claims are entitled.

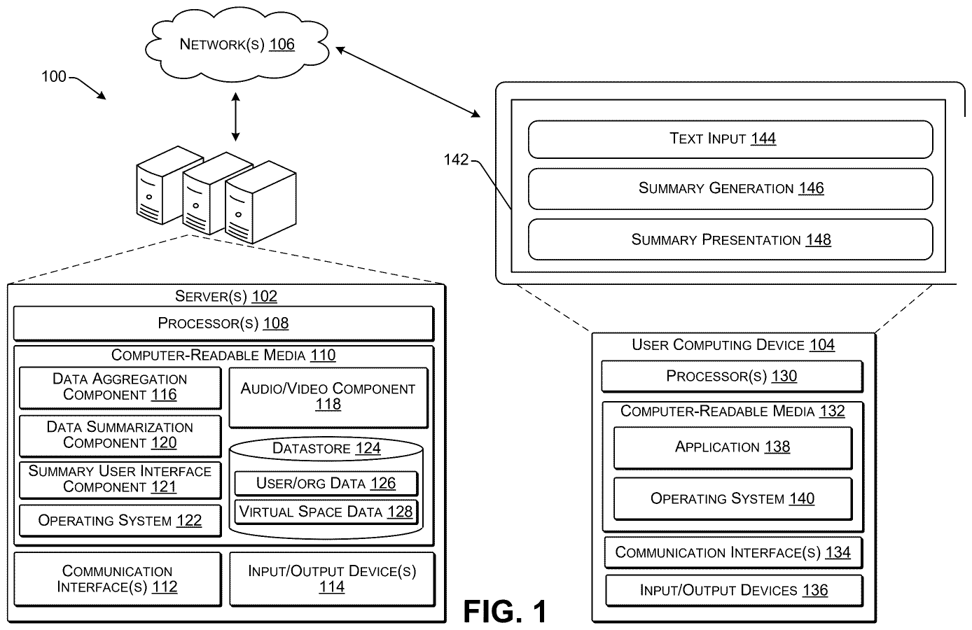

FIG. 1 illustrates an example environment 100 for performing techniques described herein. In at least one example, the example environment 100 can be associated with a communication platform that can leverage a network-based computing system to enable users of the communication platform to exchange data. In at least one example, the communication platform can be “group-based” such that the platform, and associated systems, communication channels, messages, collaborative documents, canvases, audio/video conversations, and/or other virtual spaces, have security (that can be defined by permissions) to limit access to a defined group of users. In some examples, such groups of users can be defined by group identifiers, as described above, which can be associated with common access credentials, domains, or the like. In some examples, the communication platform can be a hub, offering a secure and private virtual space to enable users to chat, meet, call, collaborate, transfer files or other data, or otherwise communicate between or among each other. As described above, each group can be associated with a workspace, enabling users associated with the group to chat, meet, call, collaborate, transfer files or other data, or otherwise communicate between or among each other in a secure and private virtual space. In some examples, members of a group, and thus workspace, can be associated with a same organization. In some examples, members of a group, and thus workspace, can be associated with different organizations (e.g., entities with different organization identifiers).

In at least one example, the example environment 100 can include one or more server computing devices (or “server(s)”) 102. In at least one example, the server(s) 102 can include one or more servers 102 or other types of computing devices that can be embodied in any number of ways. For example, in the example of a server 102, the functional components and data can be implemented on a single server 102, a cluster of servers 102, a server farm or data center, a cloud-hosted computing service, a cloud-hosted storage service, and so forth, although other computer architectures can additionally or alternatively be used.

In at least one example, the server(s) 102 can communicate with a user computing device 104 via one or more network(s) 106. That is, the server(s) 102 and the user computing device 104 can transmit, receive, and/or store data (e.g., content, information, or the like) using the network(s) 106, as described herein. The user computing device 104 can be any suitable type of computing device 104, e.g., portable, semi-portable, semi-stationary, or stationary. Some examples of the user computing device 104 can include a tablet computing device 104, a smart phone, a mobile communication device, a laptop, a netbook, a desktop computing device 104, a terminal computing device 104, a wearable computing device 104, an augmented reality device, an Internet of Things (IOT) device, or any other computing device 104 capable of sending communications and performing the functions according to the techniques described herein. While a single user computing device 104 is shown, in practice, the example environment 100 can include multiple (e.g., tens of, hundreds of, thousands of, millions of) user computing devices 104. In at least one example, user computing devices 104, such as the user computing device 104, can be operable by users to, among other things, access communication services via the communication platform. A user can be an individual, a group of individuals, an employer, an enterprise, an organization, and/or the like.

The network(s) 106 can include, but are not limited to, any type of network known in the art, such as a local area network or a wide area network, the Internet, a wireless network, a cellular network, a local wireless network, Wi-Fi and/or close-range wireless communications, Bluetooth®, Bluetooth Low Energy (BLE), Near Field Communication (NFC), a wired network, or any other such network, or any combination thereof. Components used for such communications can depend at least in part upon the type of network, the environment selected, or both. Protocols for communicating over such network(s) 106 are well known and are not discussed herein in detail.

In at least one example, the server(s) 102 can include one or more processors 108, computer-readable media 110, one or more communication interfaces 112, and/or input/output devices 114.

In at least one example, each processor of the processor(s) 108 can be a single processing unit or multiple processing units, and can include single or multiple computing units or multiple processing cores. The processor(s) 108 can be implemented as one or more microprocessors, microcomputers, microcontrollers, digital signal processors, central processing units (CPUs), graphics processing units (GPUs), tensor processing units (TPUs), state machines, logic circuitries, and/or any devices that manipulate signals based on operational instructions. For example, the processor(s) 108 can be one or more hardware processors and/or logic circuits of any suitable type specifically programmed or configured to execute the algorithms and processes described herein. The processor(s) 108 can be configured to fetch and execute computer-readable instructions stored in the computer-readable media, which can program the processor(s) to perform the functions described herein.

The computer-readable media 110 can include volatile and nonvolatile memory and/or removable and non-removable media implemented in any type of technology for storage of data, such as computer-readable instructions, data structures, program modules, or other data. Such computer-readable media 110 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired data and that can be accessed by a user computing device 104. Depending on the configuration of the server(s) 102, the computer-readable media 110 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 110 can be used to store any number of functional components that are executable by the processor(s) 108. In many implementations, these functional components comprise instructions or programs that are executable by the processor(s) 108 and that, when executed, specifically configure the processor(s) 108 to perform the actions attributed above to the server(s) 102. Functional components stored in the computer-readable media can optionally include a data aggregation component 116, an audio/video component 118, a data summarization component 120, a summary user interface component 121, an operating system 122, and a datastore 124.

In at least one example, a messaging component can process messages between users. That is, in at least one example, the messaging component can receive an outgoing message from a user computing device 104 and can send the message as an incoming message to a second user computing device 104. The messages can include direct messages sent from an originating user to one or more specified users and/or communication channel messages sent via a communication channel from the originating user to the one or more users associated with the communication channel. Additionally, the messages can be transmitted in association with a collaborative document, canvas, or other collaborative space. In at least one example, the canvas can include a flexible canvas for curating, organizing, and sharing collections of information for a particular user and/or between multiple users. In at least one example, the collaborative document can be associated with a document identifier (e.g., virtual space identifier, communication channel identifier, etc.) configured to enable messaging functionalities attributable to a virtual space (e.g., a communication channel) within the collaborative document. That is, the collaborative document can be treated as, and include the functionalities associated with, a virtual space, such as a communication channel. The virtual space, or communication channel, can be a data route used for exchanging data between and among systems and devices associated with the communication platform.

In at least one example, the messaging component can establish a communication route between and among various user computing devices 104, allowing the user computing devices 104 to communicate and share data between and among each other. In at least one example, the messaging component can manage such communications and/or sharing of data. In some examples, data associated with a virtual space, such a collaborative document, can be presented via a user interface. In addition, metadata associated with each message transmitted via the virtual space, such as a timestamp associated with the message, a sending user identifier, a recipient user identifier, a conversation identifier and/or a root object identifier (e.g., conversation associated with a thread and/or a root object), and/or the like, can be stored in association with the virtual space.

In various examples, the messaging component can receive a message transmitted in association with a virtual space (e.g., direct message instance, communication channel, canvas, collaborative document, etc.). In various examples, the messaging component can identify one or more users associated with the virtual space and can cause a rendering of the message in association with instances of the virtual space on respective user computing devices 104. In various examples, the messaging component can identify the message as an update to the virtual space and, based on the identified update, can cause a notification associated with the update to be presented in association with a sidebar of user interface associated with one or more of the user(s) associated with the virtual space. For example, the messaging component can receive, from a first user account, a message transmitted in association with a virtual space. In response to receiving the message (e.g., interaction data associated with an interaction of a first user with the virtual space), the messaging component can identify a second user associated with the virtual space (e.g., another user that is a member of the virtual space). In some examples, the messaging component can cause a notification of an update to the virtual space to be presented via a sidebar of a user interface associated with a second user account of the second user. In some examples, the messaging component can cause the notification to be presented in response to a determination that the sidebar of the user interface associated with the second user account includes an affordance associated with the virtual space. In such examples, the notification can be presented in association with the affordance associated with the virtual space.

In various examples, the messaging component can be configured to identify a mention or tag associated with the message transmitted in association with the virtual space. In at least one example, the mention or tag can include an @mention (or other special character) of a user identifier that is associated with the communication platform. The user identifier can include a username, real name, or other unique identifier that is associated with a particular user. In response to identifying the mention or tag of the user identifier, the messaging component can cause a notification to be presented on a user interface associated with the user identifier, such as in association with an affordance associated with the virtual space in a sidebar of a user interface associated with the particular user and/or in a virtual space associated with mentions and reactions. That is, the messaging component can be configured to alert a particular user that they were mentioned in a virtual space.

In at least one example, the audio/video component 118 can be configured to manage audio and/or video communications between and among users. In some examples, the audio and/or video communications can be associated with an audio and/or video conversation. In at least one example, the audio and/or video conversation can include a discrete identifier configured to uniquely identify the audio and/or video conversation. In some examples, the audio and/or video component 118 can store user identifiers associated with user accounts of members of a particular audio and/or video conversation, such as to identify user(s) with appropriate permissions to access the particular audio and/or video conversation.

In some examples, communications associated with an audio and/or video conversation (“conversation”) can be synchronous and/or asynchronous. That is, the conversation can include a real-time audio and/or video conversation between a first user and a second user during a period of time and, after the first period of time, a third user who is associated with (e.g., is a member of) the conversation can contribute to the conversation. The audio/video component 118 can be configured to store audio and/or video data associated with the conversation, such as to enable users with appropriate permissions to listen and/or view the audio and/or video data.

In some examples, the audio/video component 118 can be configured to generate a transcript of the conversation, and can store the transcript in association with the audio and/or video data. The transcript can include a textual representation of the audio and/or video data. In at least one example, the audio/video component 118 can use known speech recognition techniques to generate the transcript. In some examples, the audio/video component 118 can generate the transcript concurrently or substantially concurrently with the conversation. That is, in some examples, the audio/video component 118 can be configured to generate a textual representation of the conversation while it is being conducted. In some examples, the audio/video component 118 can generate the transcript after receiving an indication that the conversation is complete. The indication that the conversation is complete can include an indication that a host or administrator associated therewith has stopped the conversation, that a threshold number of meeting attendees have closed associated interfaces, and/or the like. That is, the audio/video component 118 can identify a completion of the conversation and, based on the completion, can generate the transcript associated therewith.

In at least one example, the audio/video component 118 can be configured to cause presentation of the transcript in association with a virtual space with which the audio and/or video conversation is associated. For example, a first user can initiate an audio and/or video conversation in association with a communication channel. The audio/video component 118 can process audio and/or video data between attendees of the audio and/or video conversation, and can generate a transcript of the audio and/or video data. In response to generating the transcript, the audio/video component 118 can cause the transcript to be published or otherwise presented via the communication channel. In at least one example, the audio/video component 118 can render one or more sections of the transcript selectable for commenting, such as to enable members of the communication channel to comment on, or further contribute to, the conversation. In some examples, the audio/video component 118 can update the transcript based on the comments.

In at least one example, the audio/video component 118 can manage one or more audio and/or video conversations in association with a virtual space associated with a group (e.g., organization, team, etc.) administrative or command center. The group administrative or command center can be referred to herein as a virtual (and/or digital) headquarters associated with the group. In at least one example, the audio/video component 118 can be configured to coordinate with the messaging component and/or other components of the server(s) 102, to transmit communications in association with other virtual spaces that are associated with the virtual headquarters. That is, the messaging component can transmit data (e.g., messages, images, drawings, files, etc.) associated with one or more communication channels, direct messaging instances, collaborative documents, canvases, and/or the like, that are associated with the virtual headquarters. In some examples, the communication channel(s), direct messaging instance(s), collaborative document(s), canvas(es), and/or the like can have associated therewith one or more audio and/or video conversations managed by the audio/video component 118. That is, the audio and/or video conversations associated with the virtual headquarters can be further associated with, or independent of, one or more other virtual spaces of the virtual headquarters.

In at least some examples, the data aggregation component 116 may identify data relevant to a particular case, project, user, issue, etc. from one or more different data sources. In particular, a user and an agent may interact with one another via multiple different communication channels associated with the different data sources. The interaction may be based on an issue or problem that the user is currently experiencing and that the agent is attempting to troubleshoot and/or resolve. Such communication channels may include virtual spaces of a group-based communication platform, email messages, chat messages, telephone calls, messages exchanged via a website, etc., which may collectively be referred to as “interaction data.” Based on a search of the different communication channels, the interaction data associated with a particular case/issue is identified and aggregated. In some embodiments, the interaction data may include email or chat messages exchanged between the user and the agent, messages exchanged between the user and the agent within a communication channel of a group-based communication platform, messages exchanged via a website, such as a website associated with the agent, and/or text transcripts derived from an audio call (e.g., a telephone call) between the user and the agent. For the purpose of this discussion, a “case” may correspond to a question, feedback, or an issue associated with, provided by, or received from a user. Agents (or service representatives) use such cases to interact with customers/users and track the resolution of the issues/problems. An agent may attempt to resolve an issue/problem presented by a user by identifying the particular customer and determining the level of support that they need, capturing and documenting details relating to the case, including the particular product/service in question (if any), resolving the issue/problem, including possibly attaching a solution or article to the case, communicating/responding to the customer over their preferred communication channel (e.g., email, text, chat, telephone call, website, etc.), and ensuring that the case contains all of the relevant details and closing the case.

To retrieve/collect the interaction data, the system may make calls to one or more APIs associated with different sources in which the interaction data is stored. For instance, one or more first calls could be made to one or more first APIs associated with a database or other source/resource that stores email messages, one or more second calls could be made to one or more second APIs associated with a database or other source/resource that stores chat messages, one or more third calls could be made to one or more third APIs associated with a database or other source/resource that stores transcripts representative of telephone/audio calls, and so on. The interaction data may be stored in the same database/source, or different databases/sources. The interaction data may be internal or external to the entity or server 102 that retrieves the interaction data, generates the summarization, and/or displays the summarization via a user interface.

As the interaction data includes communications from different communication channels and is fetched/extracted from different sources of the different communication channels, the communications will likely be in different formats (e.g., email messages, text messages, chat messages, voice transcripts or audio files, written transcripts, messages from websites, and so on). For instance, the format of an email message is different than the format of a chat message, or the format of a transcript corresponding to an audio/telephone call. The service provider may create and implement logic that, after fetching/extraction of the interaction data, aggregates all of the interaction data in a form that is consistent and readable by the model(s) 216, despite the communications initially being in different formats. Then, the model(s) 216 may take the interaction data as input and extract a summarization 206 of the case that is associated with the interaction data.

As opposed to aggregating data from a single source (e.g., an email-based system), the interaction data with respect to a particular case/issue is retrieved/collected from multiple different sources. In some embodiments, each case may be associated with a case identifier that uniquely identifies that particular case. The case identifier may be assigned to an issue/problem during, or after, the first interaction with the user, regardless of the type of communication channel being utilized. The case identifier may then be associated with each interaction between the user and an agent. For instance, with respect to a particular case associated with a problem/issue being experienced by a user, the case identifier would be associated with (and assigned to) each interaction relating to the problem/issue. The generative AI model(s) 216 may conduct a search across all communication channels, and locations at which communications are stored, utilizing the case identifier and retrieve all such communications. As a result, all interactions between the user and one or more agents may be retrieved, aggregated, and processed by the generative AI model(s) 216. In view of the aggregated interaction data representing all interactions with respect to particular case, problem, and/or issue relating to a user, the resulting summarization may also be representative of all such interactions, and any agent may generate an up to date summarization of the case to access an overview and a current status of the case.

In at least some examples, a data summarization component 120 may generate a summarization of the interaction data. In some embodiments, the interaction data associated with a particular issue/case experienced by a user and being handled by an agent may be inputted into one or more generative AI models 216 (e.g., one or more LLMs). Based on the interaction data as input, the generative AI model(s) 216 may output a summarization of case/issue. The summarization may provide an overview of the case/issue, and may include portions such as identification of the issue, a summary of the issue, any troubleshooting of the issue that has occurred by an agent or the user, whether a resolution has been reached and, if so, identification of the resolution.

A summary user interface component 121 may display the summarization to the agent and/or the user. As described herein, a user interface may include an input field to include the interaction data and a user-selectable element to generate a summarization of the case/issue. Upon selection of the user-selectable element, the generated summarization may be generated by the generative AI model(s) 216 and displayed via the user interface. In some embodiments, the user and/or the agent may confirm whether the summarization is acceptable and/or accurate. If not, the user/agent can provide input and a different summarization of the case/issue may be generated. The user interface may also include a user-selectable element that allows the user and/or the agent to publish or post the summarization to a page, feed, profile, etc. associated with the case/issue, the agent, and/or the user.

As an illustrative example, assume that customer Sue and agent Bob of ABC Company are having a chat conversation about an issue or problem that Sue is experiencing with respect to a product or service that ABC Company provides. The initial interactions between Sue and Bob may cause the service provider to open a case relating to the issue/problem. Sue and Bob may interact via various types of communication channels, such as telephone calls, chat messages, email messages, and so on. The interactions between Sue and Bob may be referred to interaction data relating to the issue/problem. One or more textual transcripts that correspond to the telephone call(s) and the chat/email messages may be stored for subsequent review and/or retrieval. After the conversations/interactions between Sue and Bob, assume that Sue is still unhappy with the product/service and/or the issue/problem has not been completely resolved. The case associated with this issue/problem remains open and Sue may be transferred to a different agent (agent Mike) or, at a later time, Sue may contact ABC Company and interact with another agent (agent Carol). Or, if Bob is not available the next time Sue would like to discuss the issue/problem, Sue would need to interact with a different agent. As a result, Sue has interactions/conversations with multiple different agents about the same issue/problem. It is likely that agent Mike and agent Carol are not intimately familiar with the issue/problem that Sue is experiencing since Bob had the initial conversations with Sue. Moreover, since Sue has conducted independent conversations with different agents, each of the agents likely is not aware of the details relating to Sue's issue/problem.

Although ABC Company may maintain a log or file of Sue's interactions with each agent, it would be difficult and time-consuming for different agents to review all of the case history relating to this problem/issue. The next agent would need to review the entire file history in order to have an adequate understanding of the issue/problem, what troubleshooting has occurred, what agents Sue has interacted with, and whether any diagnosis or resolution has fully or partially occurred. It would be beneficial for the next agent that handles this problem/issue for Sue to have a summary of what conversations have occurred thus far. Not only that, but providing a summary would reduce computational resources that would be needed for the next agent to access each source where relevant information may be found. As described herein, the system may identify all interaction data relating to this issue/problem that Sue is experiencing. The interaction data may include any messages or interactions that Sue has had with agents of ABC Company, including interactions using different communication channels (e.g., email messages, chat messages, telephone calls, etc.). The interaction data may be fed into one or more generative AI models 216 that are configured to process the interaction data and generate a summarization of the case to date. That way, the next agent that handles the issue/problem may generate the summarization and quickly have an overview of the case prior to interacting with the customer (i.e., Sue) to further resolve the issue/problem. For instance, after Bob interacts with Sue, agents Mike and/or Carol may generate a summarization of the case and quickly understand a current status of the issue/problem prior to interacting with Sue. For the purposes of this disclosure, a summarization of a case may be generated by the generative AI model(s) 216 at any point of time. Accordingly, any agent or user may generate a summarization of a case to determine an overview of the case, as well as a current status of the case (e.g., issue/problem identified, troubleshooting, suggested solutions, partial resolution, complete resolution, etc.). In some embodiments, the summarization may be automatically generated when an agent ceases interacting with the user during a particular session (or when that session ends), when that same agent again interacts with the user at a later time and possibly via a different communication channel, and/or when a new agent interacts with the user with respect to the same case (e.g., the same problem/issue). The session may correspond to the end of a chat message exchange, the end of a telephone/audio call, the end of interactions between an agent and a user on a particular day, etc.

Moreover, once the problem/issue has been fully resolved, an agent may generate a final summarization of the problem/issue for further reference. For instance, regardless of the number of agents that assisted a user with respect to a problem/issue, and regardless of the number of communication channels (e.g., email, chat, telephone calls, etc.) used for interactions between the customer and the agent, a summarization of the entire case, including the final resolution, the solutions(s), unsuccessful solutions, etc., may be generated. The summarization of a case after the case has been resolved may be useful in resolving future cases, problems, issue, etc. that may have similar characteristics. In some embodiments, the summarization(s) may be used as training data to further train the generative AI model(s) 216. Moreover, at a time that the case is closed, the summarization may be automatically generated and saved in association with the case.

In some examples, the communication platform can manage communication channels. In some examples, the communication platform can be a channel-based messaging platform, that in some examples, can be usable by group(s) of users. Users of the communication platform can communicate with other users via communication channels. A communication channel, or virtual space, can be a data route used for exchanging data between and among systems and devices associated with the communication platform. In some examples, a channel can be a virtual space where people can post messages, documents, and/or files. In some examples, access to channels can be controlled by permissions. In some examples, channels can be limited to a single organization, shared between different organizations, public, private, or special channels (e.g., hosted channels with guest accounts where guests can make posts but are prevented from performing certain actions, such as inviting other users to the channel). In some examples, some users can be invited to channels via email, channel invites, direct messages, text messages, and the like. Examples of channels and associated functionality are discussed throughout this disclosure.

In at least one example, the operating system 122 can manage the processor(s) 108, computer-readable media 110, hardware, software, etc. of the server(s) 102.

In at least one example, the datastore 124 can be configured to store data that is accessible, manageable, and updatable. In some examples, the datastore 124 can be integrated with the server(s) 102, as shown in FIG. 1. In other examples, the datastore 124 can be located remotely from the server(s) 102 and can be accessible to the server(s) 102 and/or user device(s), such as the user device 104. The datastore 124 can comprise multiple databases, which can include user/org data 126 and/or virtual space data 128. Additional or alternative data may be stored in the data store and/or one or more other data stores.

In at least one example, the user/org data 126 can include data associated with users of the communication platform. In at least one example, the user/org data 126 can store data in user profiles (which can also be referred to as “user accounts”), which can store data associated with a user, including, but not limited to, one or more user identifiers associated with multiple, different organizations or entities with which the user is associated, one or more communication channel identifiers associated with communication channels to which the user has been granted access, one or more group identifiers for groups (or, organizations, teams, entities, or the like) with which the user is associated, an indication whether the user is an owner or manager of any communication channels, an indication whether the user has any communication channel restrictions, a plurality of messages, a plurality of emojis, a plurality of conversations, a plurality of conversation topics, an avatar, an email address, a real name (e.g., John Doe), a username (e.g., j doe), a password, a time zone, a status, a token, and the like.

In at least one example, the user/org data 126 can include permission data associated with permissions of individual users of the communication platform. In some examples, permissions can be set automatically or by an administrator of the communication platform, an employer, enterprise, organization, or other entity that utilizes the communication platform, a team leader, a group leader, or other entity that utilizes the communication platform for communicating with team members, group members, or the like, an individual user, or the like. Permissions associated with an individual user can be mapped to, or otherwise associated with, an account or profile within the user/org data 126. In some examples, permissions can indicate which users can communicate directly with other users, which channels a user is permitted to access, restrictions on individual channels, which workspaces the user is permitted to access, restrictions on individual workspaces, and the like. In at least one example, the permissions can support the communication platform by maintaining security for limiting access to a defined group of users. In some examples, such users can be defined by common access credentials, group identifiers, or the like, as described above.

In at least one example, the user/org data 126 can include data associated with one or more organizations of the communication platform. In at least one example, the user/org data 126 can store data in organization profiles, which can store data associated with an organization, including, but not limited to, one or more user identifiers associated with the organization, one or more virtual space identifiers associated with the organization (e.g., workspace identifiers, communication channel identifiers, direct message instance identifiers, collaborative document identifiers, canvas identifiers, audio/video conversation identifiers, etc.), an organization identifier associated with the organization, one or more organization identifiers associated with other organizations that are authorized for communication with the organization, and the like.

In at least one example, the virtual space data 128 can include data associated with one or more virtual spaces associated with the communication platform. The virtual space data 128 can include textual data, audio data, video data, images, files, and/or any other type of data configured to be transmitted in association with a virtual space. Non-limiting examples of virtual spaces include workspaces, communication channels, direct messaging instances, collaborative documents, canvases, and audio and/or video conversations. In at least one example, the virtual space data can store data associated with individual virtual spaces separately, such as based on a discrete identifier associated with each virtual space. In some examples, a first virtual space can be associated with a second virtual space. In such examples, first virtual space data associated with the first virtual space can be stored in association with the second virtual space. For example, data associated with a collaborative document that is generated in association with a communication channel may be stored in association with the communication channel. For another example, data associated with an audio and/or video conversation that is conducted in association with a communication channel can be stored in association with the communication channel.

As discussed above, each virtual space of the communication platform can be assigned a discrete identifier that uniquely identifies the virtual space. In some examples, the virtual space identifier associated with the virtual space can include a physical address in the virtual space data 128 where data related to that virtual space is stored. A virtual space may be “public,” which may allow any user within an organization (e.g., associated with an organization identifier) to join and participate in the data sharing through the virtual space, or a virtual space may be “private,” which may restrict data communications in the virtual space to certain users or users having appropriate permissions to view. In some examples, a virtual space may be “shared,” which may allow users associated with different organizations (e.g., entities associated with different organization identifiers) to join and participate in the data sharing through the virtual space. Shared virtual spaces (e.g., shared channels) may be public such that they are accessible to any user of either organization, or they may be private such that they are restricted to access by certain users (e.g., users with appropriate permissions) of both organizations.

In some examples, the datastore 124 can be partitioned into discrete items of data that may be accessed and managed individually (e.g., data shards). Data shards can simplify many technical tasks, such as data retention, unfurling (e.g., detecting that message contents include a link, crawling the link's metadata, and determining a uniform summary of the metadata), and integration settings. In some examples, data shards can be associated with organizations, groups (e.g., workspaces), communication channels, users, or the like.

In some examples, individual organizations can be associated with a database shard within the datastore 124 that stores data related to a particular organization identification. For example, a database shard may store electronic communication data associated with members of a particular organization, which enables members of that particular organization to communicate and exchange data with other members of the same organization in real time or near-real time. In this example, the organization itself can be the owner of the database shard and has control over where and how the related data is stored. In some examples, a database shard can store data related to two or more organizations (e.g., as in a shared virtual space).

In some examples, individual groups can be associated with a database shard within the datastore 124 that stores data related to a particular group identification (e.g., workspace). For example, a database shard may store electronic communication data associated with members of a particular group, which enables members of that particular group to communicate and exchange data with other members of the same group in real time or near-real time. In this example, the group itself can be the owner of the database shard and has control over where and how the related data is stored.

In some examples, a virtual space can be associated with a database shard within the datastore 124 that stores data related to a particular virtual space identification. For example, a database shard may store electronic communication data associated with the virtual space, which enables members of that particular virtual space to communicate and exchange data with other members of the same virtual space in real time or near-real time. As discussed above, the communications via the virtual space can be synchronous and/or asynchronous. In at least one example, a group or organization can be the owner of the database shard and can control where and how the related data is stored.

In some examples, individual users can be associated with a database shard within the datastore 124 that stores data related to a particular user account. For example, a database shard may store electronic communication data associated with an individual user, which enables the user to communicate and exchange data with other users of the communication platform in real time or near-real time. In some examples, the user itself can be the owner of the database shard and has control over where and how the related data is stored.

In some examples, such as when a channel is shared between two organizations, each organization can be associated with its own encryption key. When a user associated with one organization posts a message or file to the shared channel it can be encrypted in the datastore 124 with the encryption key specific to the organization and the other organization can decrypt the message or file prior to accessing the message or file. Further, in examples where organizations are in different geographical areas, data associated with a particular organization can be stored in a location corresponding to the organization and temporarily cached at a location closer to a client (e.g., associated with the other organization) when such messages or files are to be accessed. Data can be maintained, stored, and/or deleted in the datastore 124 in accordance with a data governance policy associated with each specific organization.

The communication interface(s) 112 can include one or more interfaces and hardware components for enabling communication with various other devices (e.g., the user computing device 104), such as over the network(s) 106 or directly. In some examples, the communication interface(s) 112 can facilitate communication via WebSockets, Application Programming Interfaces (APIs) (e.g., using API calls), Hypertext Transfer Protocols (HTTPs), etc.

The server(s) 102 can further be equipped with various input/output devices 114 (e.g., I/O devices). Such I/O devices 114 can include a display, various user interface controls (e.g., buttons, joystick, keyboard, mouse, touch screen, etc.), audio speakers, connection ports and so forth.

In at least one example, the user computing device 104 can include one or more processors 130, computer-readable media 132, one or more communication interfaces 134, and input/output devices 136.

In at least one example, each processor of the processor(s) 130 can be a single processing unit or multiple processing units, and can include single or multiple computing units or multiple processing cores. The processor(s) 130 can comprise any of the types of processors described above with reference to the processor(s) 108 and may be the same as or different than the processor(s) 108.

The computer-readable media 132 can comprise any of the types of computer-readable media 132 described above with reference to the computer-readable media 110 and may be the same as or different than the computer-readable media 110. Functional components stored in the computer-readable media can optionally include at least one application 138 and an operating system 140.

In at least one example, the application 138 can be a mobile application, a web application, or a desktop application, which can be provided by the communication platform or which can be an otherwise dedicated application. In some examples, individual user computing devices 104 associated with the environment 100 can have an instance or versioned instance of the application 138, which can be downloaded from an application store, accessible via the Internet, or otherwise executable by the processor(s) 130 to perform operations as described herein. That is, the application 138 can be an access point, enabling the user computing device 104 to interact with the server(s) 102 to access and/or use communication services available via the communication platform. In at least one example, the application 138 can facilitate the exchange of data between and among various other user computing devices 104, for example via the server(s) 102. In at least one example, the application 138 can present user interfaces, as described herein. In at least one example, a user can interact with the user interfaces via touch input, keyboard input, mouse input, spoken input, or any other type of input.

A non-limiting example of a user interface 142 is shown in FIG. 1. As illustrated in FIG. 1, the user interface 142 may include a text input 144 field, a summary generation 146 field, and a summary presentation 148 field. The text input 144 field may allow an agent or a user to input any text regarding the case, or the problem/issue that the user is experiencing. The summary generation 146 field may include a user-selectable element that causes a summarization of the case to be generated. The summary presentation 148 field may display the summarization of the case upon selection of the user-selectable element associated with the summary generation field 146.

In at least one example, the operating system 140 can manage the processor(s) 130, computer-readable media 132, hardware, software, etc. of the server(s) 102.

The communication interface(s) 134 can include one or more interfaces and hardware components for enabling communication with various other devices (e.g., the user computing device 104), such as over the network(s) 106 or directly. In some examples, the communication interface(s) 134 can facilitate communication via WebSockets, APIs (e.g., using API calls), HTTPs, etc.

The user computing device 104 can further be equipped with various input/output devices 136 (e.g., I/O devices). Such I/O devices 136 can include a display, various user interface controls (e.g., buttons, joystick, keyboard, mouse, touch screen, etc.), audio speakers, connection ports and so forth.

While techniques described herein are described as being performed by the messaging component, the audio/video component 118, and the application 138, techniques described herein can be performed by any other component, or combination of components, which can be associated with the server(s) 102, the user computing device 104, or a combination thereof.

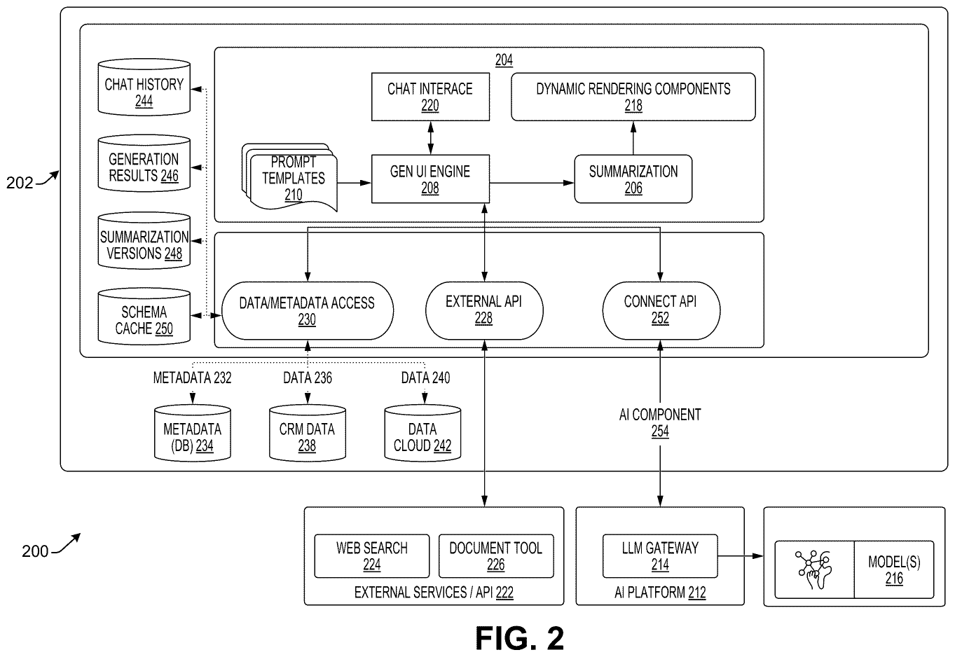

FIG. 2 illustrates an example architecture for generating a summarization of a case utilizing one or more machine-learned models 216 and/or generative AI models 216, where the case is associated with a problem or issue that is being experienced by a user and that is being addressed by one or more agents. The summarization of a case may provide an overview and/or a current status of the case, including identification of the issue/problem, troubleshooting that has occurred to date, potential resolutions to the issue/problem, and/or a final resolution. Accordingly, the summarization may allow a user/agent to become familiar with a case very quickly and efficiently, as opposed to having to read/review an entire file of a history of interactions corresponding to the issue/problem. The summarization may be generated by a user/agent at any point prior to final resolution of the issue/problem, or after a final resolution of the issue/problem and after the case has been closed.

Using the illustrative example described above, customer Sue may be experiencing a problem/issue with a product/service provided by ABC Company and may contact agent Bob for assistance. The interaction between Sue and Bob may occur via a variety of communication channels, such as email messages, chat messages, telephone calls, an exchange via a website, etc. As a result of Sue contacting an agent, a case associated with the problem/issue is opened and a history of communications/interactions associated with the case is maintained. Sue and Bob may interact during a session, but the problem/issue may not be resolved. During a next interaction between Sue and an agent (Bob or a different agent), regardless of whether the interaction is via the same communication channel or a different communication channel, the agent may have forgotten details of the case or may be entirely new to the case, which may prevent the agent from being able to competently assist Sue with their problem/issue. Instead of having to review the entire history of the interactions between Sue and the agent(s), including reviewing any troubleshooting that has been attempted by the agent(s), the agent may cause one or more generative AI models 216 (e.g., LLMs) to automatically generate a summarization of the case. The summarization may include various information about the case that helps an agent understand a current status of the case and an overview of what has occurred to date. For instance, the summarization may identify the problem/issue, briefly describe the issue/problem, identify any troubleshooting that has occurred to resolve the issue, summarize potential resolutions, and so on. Accordingly, instead of the returning agent or the new agent having to review the entire history of the case, or possibly navigating to different communication channel sources to review different forms of communication that have been used in association with the case (e.g., text messages, chat messages, emails, transcripts corresponding to telephone/audio calls, etc.), the agent need only generate the summarization and quickly and efficient come up to speed with respect to the issue/problem associated with the case.

If not for the summarization, the agent would be forced to navigate between many different sources to obtain relevant information, resulting in a “swivel chair” experience that is time consuming and resource intensive. For instance, a significant amount of computing resources are required to navigate and toggle between different sources to obtain the information that the agent would need to review to understand a current status of the case. In other words, computing resources of the device being utilized by the user, as well as one or more servers that facilitate the agent accessing such resources, are consumed by the agent attempting to find relevant information by accessing a first resource (e.g., an email-based system), then accessing a second resource (e.g., a chat-based system), then accessing a third resource (e.g., a database that stores transcripts corresponding to telephone/audio calls), then accessing a fourth resource (e.g., messages exchanged via website), and so on. Consumption of such computing resources would likely result in latency across different networks and different users, would require additional storage requirements to initially store and maintain the relevant content, and a reduction in network bandwidth.

By retrieving relevant content related to a case (e.g., interaction data) from many different resources, aggregating the interaction data, automatically generating a summarization using one or more generative AI models 216, and dynamically rendering the summarization within a single user interface, the agent need only access the summarization in order to comprehend a case, and the issue/problem that prompted opening of the case, and to determine a current status of the case and potential next steps to resolve the issue/problem. As a result, the agent need not navigate to, and toggle between, different sources to retrieve the interaction data, thereby reducing computing resources consumed by the user. The agent also would not need to utilize a significant amount of time reviewing the interaction data, which would reduce processing requirements required to render such data. Since the summarization is generated and stored in association with the case, the system need not present all of the history of the case to the agent, thereby reducing processing and storage requirements. Moreover, since the agent is not navigating between different resources, and can view the summarization within a single user interface, the agent will not be consuming as much network resources, resulting in additional network bandwidth for other agents/users and corresponding devices.

Furthermore, the systems and processes described therein provide one or more technological solutions to one or more technological problems. For instance, an agent handling an issue/problem for a user is likely able to manually access and retrieve interaction data associated with that case from multiple different communication channels (e.g., email-based systems, chat-based systems, websites, transcripts corresponding to telephone/audio calls, etc.), where the interaction data could be used to identify, diagnose, and resolve the issue/problem. However, due to the amount of interaction that is to be reviewed prior to interacting with the user and due to the user expecting to interact with an agent that is knowledgeable of their issue/problem, the ability of the agent to identify, retrieve, aggregate, and process data relevant to the case is incredibly difficult, time consuming, and resource intensive. Moreover, it may be difficult for an agent to know which communication channel sources to access and search, to identify which interaction data is relevant to the current issue/problem, and to quickly receive an overview of the case and a current status of the case. The systems and processes described herein utilize one or more models 216 (e.g., generative AI models 216, LLMs, machine learning models 216, etc.) to identify all interaction data with respect to communications between a user and one or more agents, retrieve and aggregate the relevant interaction data, automatically generate a summarization of the case, and then dynamically render the summarization within a user interface that is accessible to the agent(s). Moreover, as additional interactions that relate to the case occur between the user and agents, the systems and processes described herein may dynamically update the summarization such that the summarization is reflective of the current status of the issue/problem and potential resolution thereof. The user need only initiate a summarization of the case and the model(s) 216 automatically generates the summarization for rendering via a user interface. A summarization of the case may be initiated at any point in time prior to the issue/problem being completely resolved and the case being closed, or even afterwards.

FIG. 2 illustrates an architecture 200 for generating a summarization of a case (or otherwise referred to as “summarization” 206) and, more specifically, of a problem/issue being experienced by a user and being addressed by an agent. Components and/or modules within 202 are maintained by, or associated with, one or more servers associated with a service provider that maintains interaction data between users and agents and generates summarizations 206 associated therewith. Within box 204 resides a gen user interface (UI) engine 208, also referred to herein as a generative UI service. The gen UI engine 208 determines causes rendering of the summarizations 206 within a user interface that is accessible to agents and/or users. The gen UI engine 208 utilizes one or more prompt templates 210 to determine how and/or where the summarization 206 is to be rendered via the user interface. The gen UI engine 208 also utilizes the prompt template(s) 210 to determine which content is to be include within, and displayed in association with, the summarizations 206.

The architecture 200 also includes an AI platform 212 including an LLM gateway 214 that is associated with the service provider. The gen UI engine 208 may call the LLM gateway 214 in order to leverage one or more models 216 utilized to query for, retrieve/collect, aggregate, and process the interaction data, and to generate the summarizations 206 with respect to different cases. In some embodiments, the model(s) 216 are called to determine the content to be rendered within the summarizations 206. The model(s) 216 may include LLM models 216, generative AI models 216, machine-learned models 216, and so on. Specific examples of such models 216 may include OpenAI® and/or Vertex AI®. The service provider may utilize one or more dynamic rendering components 218 to determine how to render the summarizations 206 within various user interfaces. For instance, the dynamic rendering component(s) 218 may identify a location in the user interface in which the summarizations 206 are to reside, may dynamically move, reposition, and/or modify the summarizations 206 within the user interface, can determine the amount of content to be included in the summarizations 206, and/or can determine the proper size of the summarizations 206 based on the display size of the device being utilized to access the user interface that renders the summarizations 206 (e.g., mobile telephone, laptop computer, tablet device, etc.). In some embodiments, the dynamic rendering component(s) 218 may determine a default position or location of the summarizations 206, and the agent and/or user may reposition or reorient the summarizations 206, adjust the size of the summarizations 206, and make other adjustments to the appearance of the summarizations 206 within the user interface.

The models 216 may include any type of machine learning models 216, large language models 216 (LLM) (e.g., LLM-based models), generative AI models 216, neural networks, artificial neural networks, decision trees, support-vector machines, regression analysis, Gaussian processes, convolution neural networks, recurrent neural networks, Bayesian neural networks, foundation models 216, ensemble models 216, transformers, encoders/decoders, and so on. The service provider that maintains or utilizes the models 216 to generate the summarizations 206 may utilize data maintained by the service provider to train untrained or pre-trained models 216 to generate trained models 216. For instance, the service provider may include functionality to receive real data, modified data, and/or simulated data to train one or more untrained neural networks to generate a plurality of trained neural networks. During training, weights, filters, connections between layers, and/or parameters may be adjusted for training the individual untrained neural networks to perform a task. In some instances, supervised learning/training, unsupervised learning/training, semi-supervised learning/training, reinforcement learning/training, feature learning/training, federated learning/training, and/or self learning/training may be utilized.

Additional or alternate examples of architectures may include neural networks such as ResNet-50, ResNet-101, VGG, DenseNet, PointNet, Xception, ConvNeXt, and the like; visual transformer(s) (ViT(s)), such as a bidirectional encoder from image transformers (BEiT), visual bidirectional encoder from transformers (VisualBERT), image generative pre-trained transformer (Image GPT), data-efficient image transformers (DeiT), deeper vision transformer (DeepViT), convolutional vision transformer (CvT), detection transformer (DETR), Miti-DETR, or the like; and/or general or natural language processing transformers, such as BERT, RoBERTa, XLNet, GPT-2, GPT-3, or the like.

Moreover, in various implementations, the models 216 and/or modules described herein may be classification, predictive, generative, conversational, or another form of artificial intelligence (AI) technology, such as AI model(s) 216, agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model 216 may produce a first output, which is used as input for a second AI model 216 to produce a second output. These AI technologies may be used in succession of one another, in parallel with another, or a combination of both. Furthermore, the AI technologies may be merged in a variety of implementations, for example, by bagging, boosting, stacking, etc. the AI technologies.

Referring back to FIG. 2, a chat interface 220 may be utilized to determine the case, problem, issue, etc. that the summarization 206 is to represent. For example, the chat interface 220 may be a text entry field where the agent/user can input text (e.g., one or more words or phrases, a sentence, a paragraph, etc.) that instructs the gen UI engine 208 to identify the different interaction data that are associated with a particular case and the type or amount of the interaction data that is be included in the summarizations 208. The chat interface 220 may also include suggested prompts or options that are selectable by the agent/user to generate the summarizations 206. The chat interface 220 may reside on a first page of the user interface that is utilized to generate the summarizations 206, and the chat interface 220 may be included within the summarizations 206 themselves in order to allow the user to further edit or customize the summarizations 206. For instance, once a summarization 206 has been generated, the agent/user may determine that more, less, or different content should be included within the summarization 206. Either via a text entry into the chat interface 220 or a selection of a suggested prompt, the summarization 206 may be re-generated. Although both the initially-generated summarization 206 and the re-generated summarization 206 both provide an overview of the case, the re-generated summarization 206 may vary with respect to the amount of content included, the level of specificity, different types of content that are included or excluded, and so on. In addition, the summarization 206 may include a chat interface 220 so that the agent/user can add content and/or customize the content within the summarization 206. For example, within the summarization 206, the agent/user may ask “can you regenerate the content and focus it more on the initial problem and potential resolutions?”

In some embodiments, the model(s) 216 may receive the text input by the agent/user, or interaction data retrieved from different communication channel sources, as input. The trained model(s) 216 may analyze the input in order to output information that is reflective of a summarization 206 that is representative of the case (e.g., problem, issue, etc.) at hand. In addition, the model(s) 216 may output a layout of the summarization 206 within the user interface, as well as the size and/or position of the summarization 206 within the user interface, and the amount of content that is to be included in the summarization 206.

The gen UI engine 208 may also utilize one or more external services/APIs 222 that allow for additional information (e.g., interaction data) to be obtained from different communication channel sources, and included within the summarization 206. For instance, web search 224 may be utilized to obtain information from one or more external websites that potentially include interactions or communications between agents and users. Such information may include stored messages or files that include a history of chats between the agents and the users. The external services/API 222 may also include a document tool 226 that allows for documents (e.g., PDF files, Word documents, .txt files, PowerPoint documents/slides, etc.) to be retrieved, aggregated, processed, and subsequently utilized to generate the summarization 206. Such documents may have been exchanged between the agents and the users. The document tool 222 may analyze the documents, extract information from the documents, and include that information in the interaction data utilized to generate the summarization 206. The service provider may interact with the external services/API 222 via an external API 228 maintained by the service provider.

In order for the gen UI engine 208 to render the summarization 206 within the user interface, the gen UI engine 208 may obtain various types of data via a data/metadata/access 230 component. For instance, metadata 232 may be obtained from a metadata database (DB) 234, data 236 may be obtained from customer relationship management (CRM) data 238, and data 240 may be obtained from data cloud 242. Each of these types of data may be incorporated within the prompt template(s) 210, which allows the gen UI engine 208 to determine how the summarization 206 is to be displayed/rendered within the user interface, and an amount of content and the specific type of content that is to be included within the summarization 206. For the purposes of this disclosure, CRM may refer to systems, platforms, and/or processes that help an organization manage and improve interactions with customers and/or potential customers.

The architecture 200 further includes chat history 244 that corresponds to prompts and text inputs provided by the agents/users, including the initial prompts/inputs to generate the summarizations 206 and prompts/inputs provided by the agents/users to the summarizations 206 (or sections/compartments thereof) after the summarizations 206 have been generated. That way, the system can store previous layouts and modifications to the summarizations 206 and can subsequently dynamically present the summarizations 206 to the agents/users in a preferred manner. That is, the chat history 244 may represent historical data of the cases and/or agents/users with respect to the summarizations 206 such that subsequent iterations of the summarizations 206, including the content and/or format of the summarizations 206, are consistent with previous iterations of the summarizations 206. Generation results 246 may correspond to previous instances regarding how the summarizations 206 were generated. Summarization versions 248 may correspond to different versions of the summarizations 206 over time. And schema cache 250 may correspond to a history of schemas utilized to generate instances of the summarizations 206. Schemas within the schema cache 250 may be utilized to generate subsequent iterations of the summarizations 206.

As referenced above, the AI platform 212 and the LLM gateway 214 may be utilized to access the model(s) 216. A connect API 252 and an AI component 254 may allow the gen UI engine 208 to access and be connected with the model(s) 216.

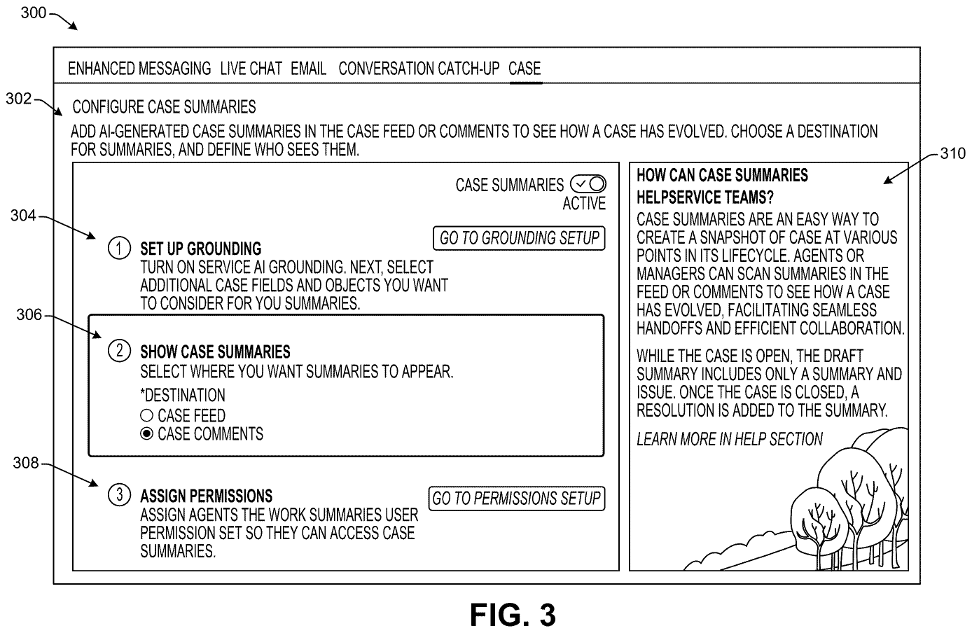

FIG. 3 illustrates a user interface 300 displaying options for generating a summarization 206 of a case. In some embodiments, the user interface 300 may be accessible to an agent that is assigned to, or that is reviewing (or will review), a case related to an issue or problem that a user or customer is experiencing. For instance, the user/customer may be experiencing a problem with a product or service offered by an entity (e.g., a company, corporation, etc.) associated with the agent. The agent may assist the user/customer in troubleshooting and ideally resolving the issue or problem encountered by the user/customer. The user interface 300 may be accessible by the agent (or any other agent) to configure options for generating summarizations of cases associated with different users/customers.

At 302, the user interface 300 depicts a description of the options provided to an agent and/or a user. As shown, reference number 302 states “configure case summaries,” “add AI-generated case summaries in the case feed or comments to see how a case has evolved,” and choose a destination for summaries, and define who sees them.” That is, this portion of the user interface 300 informs the agent that they can configure summarizations 206 of cases utilizing this user interface 300. Moreover, this portion of the user interface 300 states that the summarizations 206 are generated by the model(s) 216 (e.g., generative AI models 216, LLMs, machine learning models 216, etc.). The AI-generated summarizations 206 may indicate a current status of a case, such as identifying the issue/problem experienced by the user/customer, describing any troubleshooting that has occurred to resolve the issue, and indicate whether resolution of the problem/issue has been achieved. If the agent elects to generate a summarization 206 of the case, this portion of the user interface 300 informs the agent that they can choose a destination (e.g., a case feed, a case history, a database, etc.) where the summarization 206 may be stored for subsequent access and review.

At 304 of the user interface 300, the agent may “set up grounding” and this portion further states “turn on service AI grounding” and “[n]ext, select additional case fields and objects you want to consider for your summaries.” This portion of the user interface 300 allows the agent to select what types of data are available to the model(s) 216 to generate the summarizations 206. As a result, the model(s) 216 may have the most up-to-date data available to utilize when generating the summarizations 206. For the purpose of this disclosure, “grounding” may refer to ensuring that the model(s) 216 have access to relevant data so that the model(s) 216 output meaningful information. Here, since the model(s) 216 are configured to generate summarizations 206 of cases and corresponding problems/issues experienced by customers/issues, grounding may occur by ensuring that the model(s) 216 have access to the interaction data that represents interactions and communications between customers/users agent. In particular, for a certain case (and an issue or problem experienced by a user), the model(s) 216 would have access to interaction data associated with the user and one or more agents that are tasked with attempting to resolve the user's issue/problem. Here, that interaction data may include email messages, text messages, chat messages, etc. exchanged between the user and the agent(s). The interaction data may also include transcripts that represent telephone/audio calls between the user and the agent(s), as well as any documents that are relevant to the case. Moreover, the interaction data may include other cases where users have experienced similar issues/problems, as well as an identification of how those cases were resolved.

Grounding would infuse prompts to the model(s) 216 with the interaction data, including structured data (e.g., spreadsheets, CRM data, textual transcripts, etc.) and unstructured data (e.g., PDF documents, chat logs, email messages, blog posts, text messages). That is, the prompts would be grounded in relevant context with respect to the cases that are to be summarized. In some embodiments, the prompts may be grounded by copying and pasting relevant data (e.g., the interaction data for a case) directly into a context window of the prompts. In other embodiments, the information (e.g., the interaction data) may be organized into a vector database and a technique such as RAG may be utilized to retrieve the information. In the background, data masking tools may prevent the information entered into the prompts from being sent back to the model(s) 216, ensuring privacy and security of the information. As a result of the grounding and facilitating access to relevant information (e.g., interaction data) by the model(s) 216, the model(s) 216 may generate more accurate and personalized output. That is, grounding may result in the model(s) 216 generating, outputting, and rendering more accurate summarizations 206 for cases.

At 306, the user interface 300 may allow the agent to specify where generated case summarizations 206 are to be shown. For instance, the agent may elect to have the generated summarizations 206 to be rendered in a case feed, in case comments, within a user interface in which the summarization 206 is requested to be generated, or any other location accessible to the agent(s) or users/customers.

At 308, the user interface 300 may assign permissions to the generated summarizations 206. For instance, it may be specified whether agents and/or users are able to access and view the summarizations 206, and which agents or users have authorization to access/view the summarizations 206. The agent may assign permissions to specific agents/users, different groups of agents/users, agents/users having a certain role or type, and so on.

At 310, the user interface 300 may specify how the case summaries can help service teams. In particular, this section of the user interface 300 states that “[c]ase summaries are an easy way to create a snapshot of a case at various points in its lifecycle,” that “[a]gents or managers can scan summaries in the feed or comments to see how a case has evolved, facilitating seamless handoffs and efficient collaboration,” that “[w]hile the case is open, the draft summary includes only a summary and issue,” that “[o]nce the case is closed, a resolution is added to the summary,” and “[l]earn more in help section.” As shown, the model(s) 216 may generate summarizations 206 of a case at any point while the case is pending, including after the case has been closed and the corresponding issue/problem has been resolved. As a result, at any point in time, an agent may generate a summarization 206 of a case to review an overview or status of a case, which may be very helpful in allowing agents to become familiar with a case prior to interacting with the user/customer.

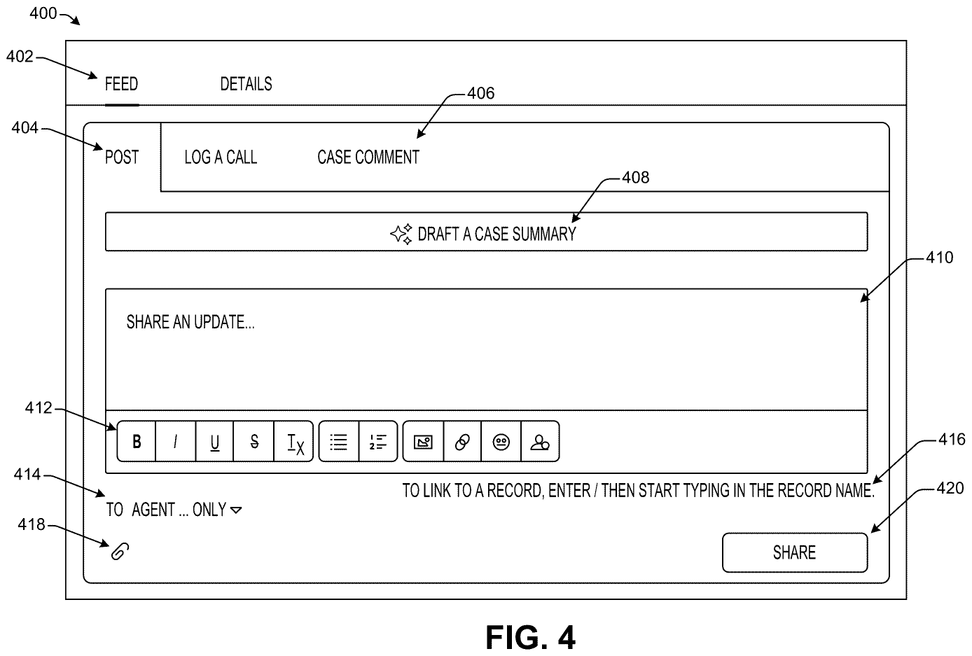

FIG. 4 illustrates a user interface 400 utilized to generate a summarization with respect to a case, where the case is associated with a problem/issue of a user and is being handled by one or more agents. As shown the user interface 400 may include a case feed tab 402, which may include a post tab 404 and a case comment tab 406. When the case feed tab 402 is selected, an agent is able to draft or generate summarizations 206 of a case via the post tab 404. When the case comment tab 406 is selected, an agent is able to draft or generate summarizations 206 of a case via a different section of the feed associated with the case. At 408, an agent is select a user-selectable element to draft or generate a summarization 206 of a case (e.g., “Draft a case summary”). That is, as a result of selecting this selectable element 408, the model(s) 216 may generate a summarization 206 of the case, where the summarization 206 may identify the problem/issue, include a summary of what has occurred to date, and identify any potential resolutions of the problem/issue. In some embodiments a default selected model 216 may be utilized to generate the summarization 206. However, in other embodiments, a model 216 different than the default model 216 may be utilized, or the agent may configure their own model 216, as well as use other third-party models 216 to generate the summarization 206.

Upon causing the model(s) 216 to generate the summarization 206, the summarization 206 may be displayed with user interface field 410 that states “share an update.” The agent may be able to edit the summarization 206 and may modify the text in various manners via 412. For instance, via the user-selectable controls 412, the agent may make text bold, italicized, underlined, strikethrough, change the font, include bullet points, include numbering, add emojis, and so on. At element 414, the agent may specify a location at which the summarization 206 is to be sent once generated and approved. For instance, the agent may cause the summarization 206 to be sent to themselves, the case file of the case, or any other location. At element 416, the agent may link the summarization 206 with a particular record or case such that the record/case and the summarization 206 are associated with one another. In some embodiments, the agent may identify the case/record utilizing the case identifier for the case, or a description of the case using natural language. At element 418, the agent may link or enclose a document associated with the case. For instance, if the user and/or the agent sent or utilized a document when identifying the problem/issue or attempting to resolve the problem/issue, such a document may be associated with the summarization 206. Moreover, once the summarization 206 has been generated and approved by the agent, the agent may select element 420 to share or post the summarization 206. As a result, the summarization 206 may be posted within a file history or other tab/page associated with the case such that the summarization 206 is available to other agents or users.

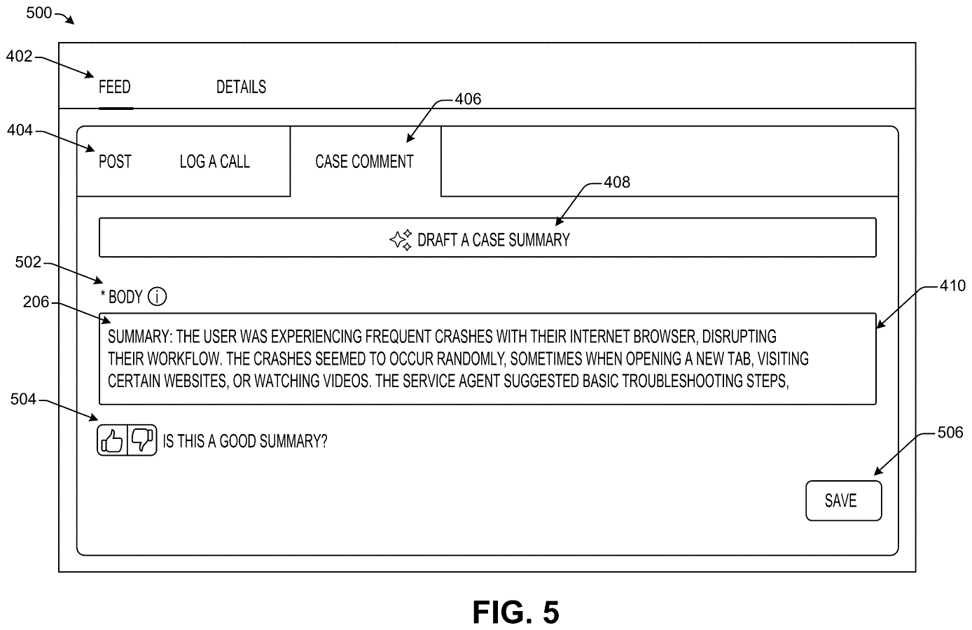

FIG. 5 illustrates a user interface 500 utilized to generate a summarization with respect to a case, where the case is associated with a problem/issue of a user and is being handled by one or more agents. Similar to FIG. 4, the user interface 500 may include a case feed tab 402, a post tab 404, and a case comment tab 406. The user interface 500 may also include a user-selectable element 408 to generate a summarization 206 (“[d]raft a case summary”). In the embodiment depicted in FIG. 5, an agent has selected user-selectable element 408 in order to generate a summarization 206 for a case. As a result, the user interface 500 includes a body section 502 where the summarization 206 is included within. As shown, the summarization 206 identifies a problem/issue that the user was experiencing (“[s]ummary: the user was experiencing frequent crashes with their internet browser, disrupting their workflow” and “[t]he crashes seemed to occur randomly, sometimes when opening a new tab, visiting certain websites, or watching videos”) and indicates that an agent attempted to troubleshoot the issue (“[t]he service agent suggested basic troubleshooting steps, . . . ”). Accordingly, instead of an agent needing to review the entire case history of a case to identify the issue/problem, determine what troubleshooting has occurred to date, and to determine whether a partial or complete resolution of the problem/issue has occurred, the agent may utilize the model(s) 216 to generate the summarization 206 and quickly learn a current status of the problem/issue.

In some embodiments, once the summarization 206 has been generated and rendered via the user interface 500, the agent may provide feedback 504 to indicate whether the summarization 206 is acceptable or not. For instance, the agent may provide a thumbs up or a thumbs down indicating that the summarization 206 was satisfactory or unsatisfactory, respectively. Other ways of providing feedback are also contemplated herein, including providing a numerical rating, inputting natural language text, utilizing a slider bar, and so on. Agents selecting the thumbs up or thumbs down elements may indicate the quality of the summarizations 206 and may be tracked by the service provider over time. The feedback may be stored by the service provider and utilized to improve the quality of the summarizations 206. Based on the feedback, the model(s) 216 maybe modified in an attempt to cause the summarizations 206 to be more accurate, more complete, etc. This feedback mechanism may be performed manually, or may be performed automatically (or may be partially automated).

As illustrated in FIG. 4, the agent may also make modifications to the summarization 206. Furthermore, if the agent is not satisfied with the summarization 206, the agent may cause the model(s) 216 to regenerate the summarization 206. Prior to regenerating the summarization 206, the agent may provide input indicating how the new summarization 206 is to be different than the previously generated summarization 206. The user interface 500 may also include a “save” option 506, which allows the agent to save the summarization 206 for subsequent retrieval and access. For instance, the summarization 206 may be saved in a file, tab, or page associated with the case, in a database, etc., in association with the case.

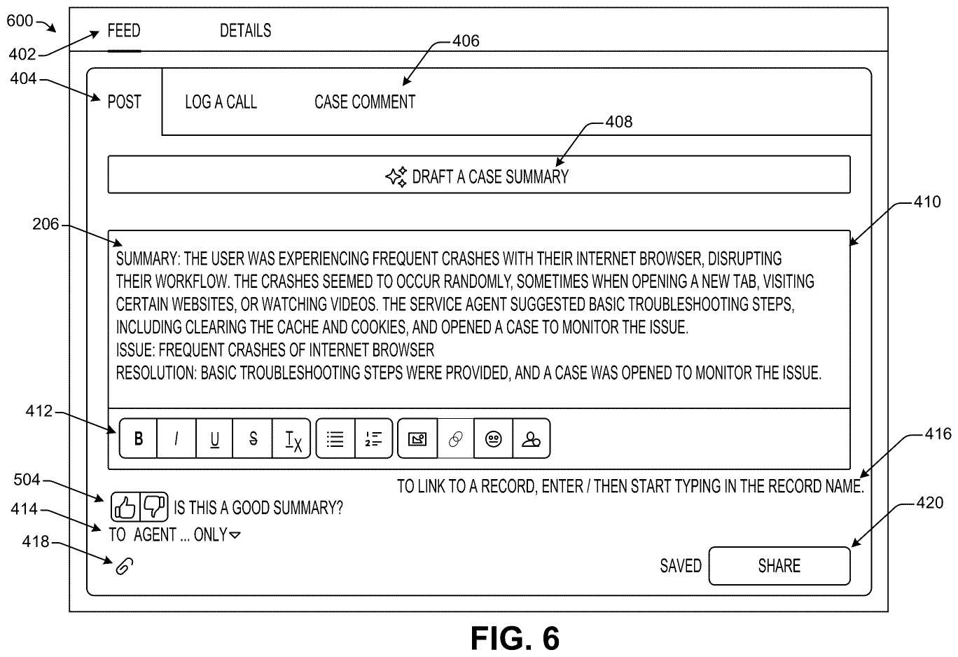

FIG. 6 illustrates a user interface 600 utilized to generate a summarization with respect to a case, where the case is associated with a problem/issue of a user and is being handled by one or more agents. Similar to FIGS. 4 and 5, the user interface 600 may include a case feed tab 402, a post tab 404, and a case comment tab 406. The user interface 600 may also include a user-selectable element 408 to generate a summarization 206 (“[d]raft a case summary”). The user interface 600 may also include elements corresponding a field 410 where the generated summarization 206 is to appear, options 412 to modify the summarization 206, an option 414 to specify to whom the summarization 206 is to be sent to (or provided access to), an option 416 to associate the summarization 206 with the corresponding case, an option 418 to enclose or associate a document with the summarization 206, an option 420 to share the summarization 206 with agents, tabs, case files, etc., and an option 504 to provide feedback regarding the summarization 206. In the embodiment depicted in FIG. 6, an agent has previously selected an option (reference number 506, not shown) to save the summarization 206.

As shown in the user interface 600, the summarization may include different sections, such as a “summary” section, an “issue” section, and a “resolution” section, although any number or types of sections may be included. The “summary” section indicates that “the user was experiencing frequent crashes with their internet browser, disrupting their workflow,” that “[t]he crashes seemed to occur randomly, sometimes when opening a new tab, visiting certain websites, or watching videos,” and that “[t]he service agent suggested basic troubleshooting steps, including clearing the cache and cookies, and opened a case to monitor the issue.” The “issue” section indicated “[f]requent crashes of internet browser” and the “resolution” section stated “[b]asic troubleshooting steps were provided, and a case was opened to monitor the issue.” As a result, an agent that previously was involved with the case may get up to speed prior to further interactions with the user, or a new agent may be provided with an overview of the case, and a current status thereof, prior to initial interactions with the user. Assuming that the agent is satisfied with the saved summarization 206, the agent may share 420 the summarization 206 with one or more agents, users, or sources, such as a file history of the case, a database that stores information related to the case, a page/tab associated with the case, and so on.

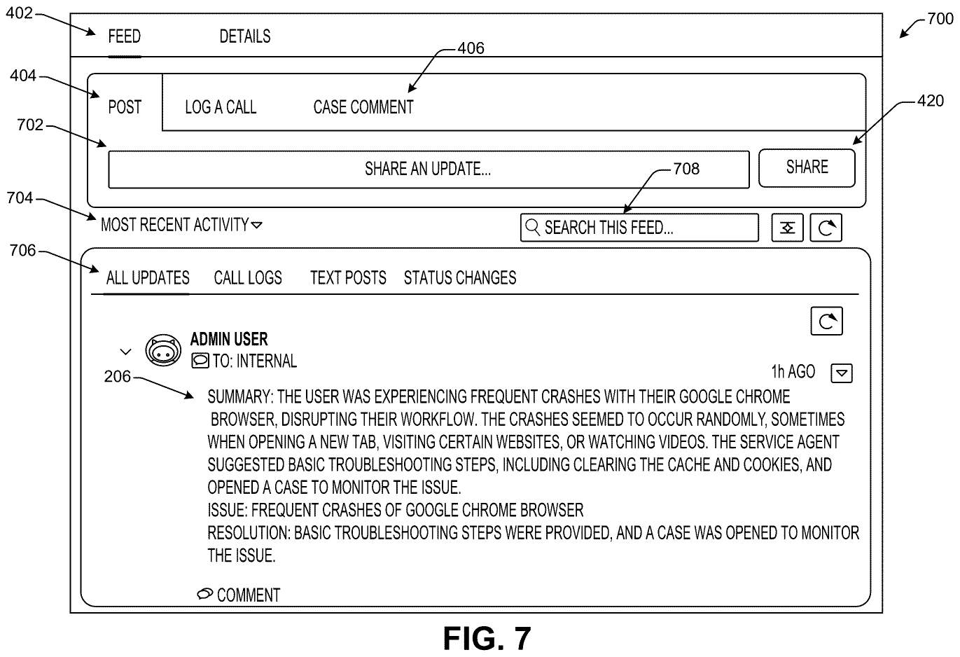

FIG. 7 illustrates a user interface 700 utilized to generate a summarization with respect to a case, where the case is associated with a problem/issue of a user and is being handled by one or more agents. Similar to FIGS. 4-6, the user interface 700 may include a case feed tab 402, a post tab 404, and a case comment tab 406. The user interface 700 may also include a user-selectable element 420 to share the summarization 206. The user interface 700 may display a summarization 206 that has already been saved and published to a site, page, tab, or any other location that is accessible to users/agents. In various embodiments, at 702, an update associated with the case or the summarization 206 may be shared. At 704, a drop-down menu may include options for determining what information is displayed via the user interface 700. For instance, most recent activity associated with the case may be displayed, previously generated summarizations 206 for the case may be displayed, most viewed activity may be displayed, and so on. The user interface 700 may also include options 706 for viewing the types of information relating to the case, such as “all updates,” which may include generated summarizations 206 for the case, “call logs” for the case, “text posts” related to the case, “status changes” related to the case, and so on. The user interface 700 may also include an option 708 to search the feed related to the case. For example, an agent may search the history of the case to identify summarizations 206 that have previously been generated for the case.

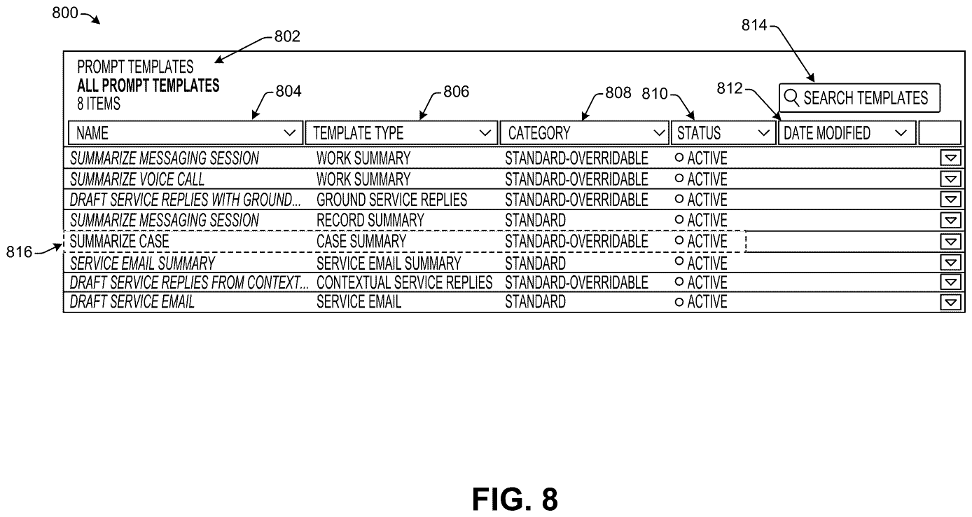

FIG. 8 illustrates a user interface 800 illustrating prompt templates 210 utilized to perform various operations associated with the service provider, including generating summarizations 206 of cases utilizing the one or more models 216 (e.g., generative AI models 216, LLMs, machine learning models 216, etc.). At 802, the user interface 800 depicts an identity of what information is included in the table depicted therein. Here, the table includes different prompt templates 210 and a total of eight prompt templates 210 are displayed, although any number and type of prompt templates 210 may be presented.

The user interface 800 includes multiple drop-down menus for filtering and sorting the different prompt templates 210. For instance, a name option 804 allows for the prompt templates 210 to be sorted/filtered by the name of the prompt templates 210 (e.g., summarize messaging session, summarize voice call, summarize case, draft service email, etc.), a template type option 806 allows for the prompt templates 210 to be sorted/filtered by the type of the prompt templates 210 (e.g., work summary, ground services replies, case summary, record summary, service email summary, contextual service replies, service email, etc.), a category option 808 allows for the prompt templates 210 to be sorted/filtered by the category of the prompt templates 210 (e.g., standard, standard-overridable, etc.), a status option 810 allows for the prompt templates 210 to be sorted/filtered by the status of the prompt templates 210 (e.g., active, inactive, etc.), and a date modified option 812 allows for the prompt templates 210 to be sorted/filtered by the last time any of the prompt templates 210 were modified. An additional option 814 allows for the prompt templates 210 to be searched or searchable via a drop-down menu, a natural language input, and so on.

As shown via the checked lines, the prompt template 210 entitled “summarize case” 816 has been selected. Such a prompt template 210 allows for the generation of a summarization 206 corresponding to a case, as described herein.

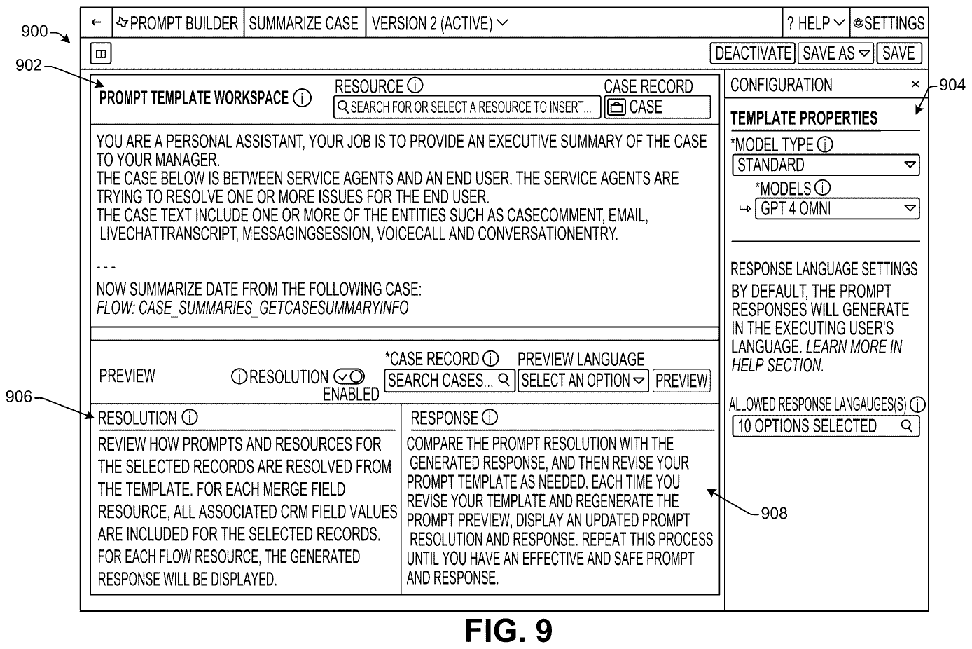

FIG. 9 illustrates a user interface 900 depicting a prompt template workspace corresponding to a prompt template 210 included in the user interface 800. Within the prompt template workspace, characteristics/details relating to a prompt template 210 may be viewed and edited/modified. For the purposes of this discussion a prompt template 210 may correspond to a reusable, pre-defined framework that allows users to create prompts for AI-powered tasks, such as the generations of summarizations 206 for cases utilizing the model(s) 216 described herein. The prompt templates 210 allow users to generate such content by dynamically collecting data from various different sources, such as the communication channel sources described herein (e.g., email-based systems, chat-based systems, websites, transcripts corresponding to telephone/audio calls, etc.). As opposed to being one-off prompts, the prompt templates 210 are designed to be utilized repeatedly to perform different tasks or operations. The prompt templates 210 may pull data from various sources, which may ensure that the prompt templates 210 are relevant to the type of data being requested and in view of the context of particular cases. Once the placeholders in the prompt templates 210 are filled with appropriate data, the prompt templates 210 may be used to generate content (e.g., the summarizations 206) using the model(s) 216 (e.g., generative AI models 216, LLMs, machine learning models 216, etc.).

A prompt template 210 relating to the summarization 206 of cases may be a reusable prompt that includes placeholders for specific details about a particular case, problem/issue, and/or user. For instance, with respect to the illustrative example described above, a prompt template 210 that is utilized to generate a summarization 206 for the case related to customer Sue may include placeholder information about customer Sue, the product/service related to the problem/issue that Sue is experiencing, the problem/issue itself, and/or the different communication channels Sue has utilized to interact with agents of ABC Company. An agent and/or administrator may add such information to the prompt template 210, or modify the prompt template 210 to include such information. That way, when the summarization 206 related to Sue's problem/issue is requested, the model(s) 216 may utilize the prompt template 210 to identify what relevant information should be included within the summarization 206. The relevant interaction data may be retrieved, aggregated, and processed to generate the summarization 206.

Referring back to FIG. 9, the user interface 900 may include different fields, sections, categories, etc. for creating, updating, and editing a prompt template 210 utilized to generate a summarization 206 of a case. For instance, the user interface 900 may include a prompt template 210 workspace 902 that allows an agent to identify information relevant to the case in question, including identifying the case (by case identifier, for instance), identifying the communication channels utilized by the user with respect to the case, and including any text that provides an overview of the issue/problem or that provides a current status of the case. The user interface 900 may also include a template properties section 904 that allows the agent to identify/update properties or characteristics about the prompt template 210 and/or the case. Such properties or characteristics may include the type of model 216 (or a specific model 216) to be utilized to generate the summarization 206 of the case and language settings, amongst other potential properties/characteristics.

The properties or characteristics of the prompt template 210 can be configured or adjusted based on various preferences, thereby generating a summarization 206 that is customized. For instance, the properties/characteristics of the prompt template 210 may be adjusted so that a tone of the summarization 206 is a certain way, so that the summarization 206 is a certain length (e.g., 10 sentences, 250 words, etc.) or has a certain length range (e.g., 5-10 sentences, 200-300 words, etc.), so that the format of the summarization 206 is a particular way, so that the summarization 206 has or does not have emojis, so that the summarization 206 is formatted in bullet points or paragraph form, etc. As stated above, the model 216 to be utilized to generate the summarization 206 may be a default model 216 selected by the service provider, a model 216 selected by the agent, a modified version of the default model 216, or any other model 216.

The user interface 900 may also include a resolution section 906 that provides information about resolution of the problem/issue associated with the case. Moreover, the user interface 900 may include a response section 908 that compares the prompt resolution with a generated response, where the comparison may be utilized to revise the prompt template 210.

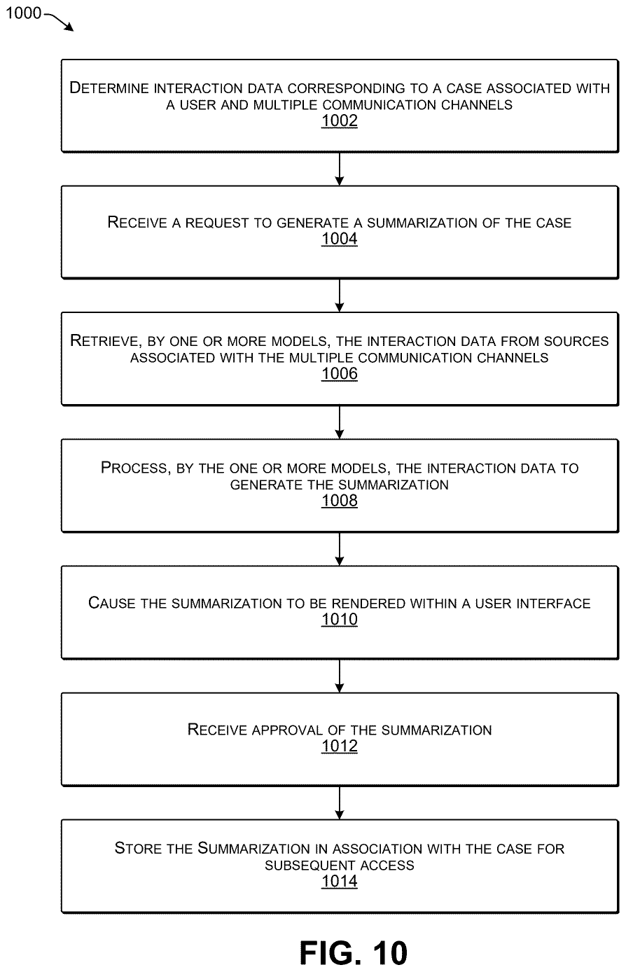

FIG. 10 is a flow diagram illustrating an example process of generating a summarization of a case utilizing one or more generative AI models 216. The processes illustrated in FIG. 10 is described with reference to components described above with reference to the example environments shown in FIGS. 1-9 for convenience and ease of understanding. However, the processes illustrated in FIG. 10 is not limited to being performed using the components described above with reference to the example environments described herein. Moreover, the components described above with reference to the example environments described herein are not limited to performing the processes illustrated in FIG. 10.

Process 1000 is illustrated as collections of blocks in a logical flow diagram, representing sequences of operations, some or all of which can be implemented in hardware, software, or a combination thereof. In the context of software, the blocks represent computer-executable instructions stored on one or more computer-readable media that, when executed by one or more processors, perform the recited operations. Generally, computer-executable instructions include routines, programs, objects, components, encryption, deciphering, compressing, recording, data structures, and the like that perform particular functions or implement particular abstract data types. The order in which the operations are described should not be construed as a limitation. Any number of the described blocks can be combined in any order and/or in parallel to implement the processes, or alternative processes, and not all of the blocks need to be executed in all examples. For discussion purposes, the processes herein are described in reference to the frameworks, architectures and environments described in the examples herein, although the processes may be implemented in a wide variety of other frameworks, architectures or environments.

At 1002, the service provider determines interaction data corresponding to a case associated with a user and multiple communication channels. In particular, a user may contact the service provider regarding a problem/issue that they are experiencing, and an agent or service representative may attempt to resolve the user's problem/issue. The user may interact with the agent(s) of the service provider utilizing multiple different types of communication channels, including email messages, chat messages, text messages, telephone/audio calls, a website, and so on.

At 1004, the service provider may receive a request to generate a summarization 206 of the case. Prior to the problem/issue being resolved, the current agent may want to have an overview or status update of the case prior to further interacting with the user. Or, if a different agent that is unfamiliar with the case is to assist the user, the new agent may desire to familiarize themselves about the case (e.g., the problem/issue, previous interactions with the user, any troubleshooting that has taken place, potential resolutions, etc.). As a result, the agent may, via a user interface, select a user-selectable control to generate the summarization 206. In other embodiments, the request to generate the summarization 206 may occur after a final resolution of the problem/issue.

At 1006, the service provider, and the one or more models 216 in particular, may retrieve the interaction data from sources associated with the multiple communication channels. For instance, upon determining which types of communication channels the user has communicated with the agent(s), the model(s) 216 may extract relevant interaction data associated with the case from the sources of those communication channels.

At 1008, the service provider and the model(s) 216 may process the interaction data to generate the summarization 206. The model(s) 216 may aggregate the extracted and collected interaction data and utilize the aggregated interaction data as input to generate the summarization 206 as output. The summarization 206 may serve as an overview of the case, and may include identification of the problem/issue, identification of the user, any troubleshooting that has occurred, and potential resolutions for the problem/issue.

At 1010, the service provider may cause the summarization to be presented within a user interface. That is, upon an agent requesting the summarization 206 of the case, the summarization 206 may be displayed to the agent. The user interface may include various other options, such as the ability of the user to provide feedback regarding the summarization 206, approve or deny the summarization 206, request that a new summarization 206 for the case be generated, and so on.

At 1012, the service provider may receive approval of the summarization. Upon reviewing the summarization 206, the agent may provide approval of the summarization 206.

At 1014, the service provider may store the summarization in association with the case for subsequent access. For instance, the summarization 206 may be stored in a feed, profile, tab, page, or any other medium that stores information about the case.

### Example Clauses

The following clauses provide various examples of implementations of the present disclosure:
A: A method comprising: receiving, from a device and via a user interface, a selection of a selectable element indicating a request to generate a summarization associated with a case, wherein the case includes communications exchanged via a plurality of different communication channels; extracting, based at least in part on the selection of the selectable element, interaction data representative of the communications from a plurality of different sources associated with the plurality of different communication channels; inputting the interaction data into one or more models that are configured to process the interaction data and generate summarizations of content; receiving, based at least in part on the interaction data and as output from the one or more models, the summarization, wherein the summarization identifies an issue associated with the case and a summary of at least one of the issue or the case; and causing the summarization to be displayed via the user interface presented on the device.
B: The method as recited in clause A, wherein the plurality of different communication channels include at least two of email messages, chat messages, text messages, audio calls, or messages exchanged via a website.
C: The method as recited in clause A, wherein the one or more models include one or more generative artificial intelligence models or one or more large language models.
D: The method as recited in clause A, further comprising: receiving, from the device and via the user interface, an indication of an approval of the summarization; and storing, based at least in part on the indication, the summarization in association with the case for subsequent access.
E: The method as recited in clause A, further comprising: causing display of a prompt template utilized to generate the summarization, wherein the prompt template includes one or more configurable characteristics; receiving a modification to the one or more configurable characteristics, wherein the modification specifies at least one of the plurality of different communication channels or the plurality of different sources; and causing the one or more models to generate the summarization based at least in part on the prompt template.
F: The method as recited in clause A, wherein the issue is presented by a user, the communications are between the user and an agent that is assigned to resolve the issue, and the request is from a different agent that is unassociated with the communications.
G: The method as recited in clause A, further comprising: determining a resolution of the issue; and generating the summarization to identify the resolution of the issue.
H: A system comprising: memory; one or more processors; and one or more computer-executable instructions stored in the memory and executable by the one or more processors to perform operations comprising: receiving, from a device and via a user interface, a selection of a selectable element indicating a request to generate a summarization associated with a case, wherein the case includes communications exchanged via a plurality of different communication channels; extracting, based at least in part on the selection of the selectable element, interaction data representative of the communications from a plurality of different sources associated with the plurality of different communication channels; inputting the interaction data into one or more models that are configured to process the interaction data and generate summarizations of content; receiving, based at least in part on the interaction data and as output from the one or more models, the summarization, wherein the summarization identifies an issue associated with the case and a summary of at least one of the issue or the case; and causing the summarization to be displayed via the user interface presented on the device.
I: The system as recited in clause H, wherein the plurality of different communication channels include at least two of email messages, chat messages, text messages, audio calls, or messages exchanged via a website.
J: The system as recited in clause H, wherein the one or more models include one or more generative artificial intelligence models or one or more large language models.
K: The system as recited in clause H, wherein the operations further comprise: receiving, from the device and via the user interface, an indication of an approval of the summarization; and storing, based at least in part on the indication, the summarization in association with the case for subsequent access.
L: The system as recited in clause H, wherein the operations further comprise: causing display of a prompt template utilized to generate the summarization, wherein the prompt template includes one or more configurable characteristics; receiving a modification to the one or more configurable characteristics, wherein the modification specifies at least one of the plurality of different communication channels or the plurality of different sources; and causing the one or more models to generate the summarization based at least in part on the prompt template.
M: The system as recited in clause H, wherein the issue is presented by a user, the communications are between the user and an agent that is assigned to resolve the issue, and the request is from a different agent that is unassociated with the communications.
N: The system as recited in clause H, wherein the operations further comprise: determining a resolution of the issue; and generating the summarization to identify the resolution of the issue.
O: One or more non-transitory computer-readable media storing one or more computer-executable instructions that, when executed by one or more processors, cause the one or more processors to perform operations comprising: receiving, from a device and via a user interface, a selection of a selectable element indicating a request to generate a summarization associated with a case, wherein the case includes communications exchanged via a plurality of different communication channels; extracting, based at least in part on the selection of the selectable element, interaction data representative of the communications from a plurality of different sources associated with the plurality of different communication channels; inputting the interaction data into one or more models that are configured to process the interaction data and generate summarizations of content; receiving, based at least in part on the interaction data and as output from the one or more models, the summarization, wherein the summarization identifies an issue associated with the case and a summary of at least one of the issue or the case; and causing the summarization to be displayed via the user interface presented on the device.
P: The one or more non-transitory computer-readable media as recited in clause O, wherein the plurality of different communication channels include at least two of email messages, chat messages, text messages, audio calls, or messages exchanged via a website, and wherein the one or more models include one or more generative artificial intelligence models or one or more large language models.
Q: The one or more non-transitory computer-readable media as recited in clause O, wherein the operations further comprise: receiving, from the device and via the user interface, an indication of an approval of the summarization; and storing, based at least in part on the indication, the summarization in association with the case for subsequent access.
R: The one or more non-transitory computer-readable media as recited in clause O, wherein the operations further comprise: causing display of a prompt template utilized to generate the summarization, wherein the prompt template includes one or more configurable characteristics; receiving a modification to the one or more configurable characteristics, wherein the modification specifies at least one of the plurality of different communication channels or the plurality of different sources; and causing the one or more models to generate the summarization based at least in part on the prompt template.
S: The one or more non-transitory computer-readable media as recited in clause O, wherein the issue is presented by a user, the communications are between the user and an agent that is assigned to resolve the issue, and the request is from a different agent that is unassociated with the communications.
T: The one or more non-transitory computer-readable media as recited in clause O, wherein the operations further comprise: determining a resolution of the issue; and generating the summarization to identify the resolution of the issue.

### Conclusion

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A method comprising:
receiving, from a device and via a user interface, a selection of a selectable element indicating a request to generate a summarization associated with a case, wherein the case includes communications exchanged via a plurality of different communication channels;
extracting, based at least in part on the selection of the selectable element, interaction data representative of the communications from a plurality of different sources associated with the plurality of different communication channels;
inputting the interaction data into one or more models that are configured to process the interaction data and generate summarizations of content;
receiving, based at least in part on the interaction data and as output from the one or more models, the summarization, wherein the summarization identifies an issue associated with the case and a summary of at least one of the issue or the case; and
causing the summarization to be displayed via the user interface presented on the device.

2. The method as recited in claim 1, wherein the plurality of different communication channels include at least two of email messages, chat messages, text messages, audio calls, or messages exchanged via a website.

3. The method as recited in claim 1, wherein the one or more models include one or more generative artificial intelligence models or one or more large language models.

4. The method as recited in claim 1, further comprising:
receiving, from the device and via the user interface, an indication of an approval of the summarization; and
storing, based at least in part on the indication, the summarization in association with the case for subsequent access.

5. The method as recited in claim 1, further comprising:
causing display of a prompt template utilized to generate the summarization, wherein the prompt template includes one or more configurable characteristics;
receiving a modification to the one or more configurable characteristics, wherein the modification specifies at least one of the plurality of different communication channels or the plurality of different sources; and
causing the one or more models to generate the summarization based at least in part on the prompt template.

6. The method as recited in claim 1, wherein the issue is presented by a user, the communications are between the user and an agent that is assigned to resolve the issue, and the request is from a different agent that is unassociated with the communications.

7. The method as recited in claim 1, further comprising:
determining a resolution of the issue; and
generating the summarization to identify the resolution of the issue.

8. A system comprising:
memory;
one or more processors; and
one or more computer-executable instructions stored in the memory and executable by the one or more processors to perform operations comprising:
receiving, from a device and via a user interface, a selection of a selectable element indicating a request to generate a summarization associated with a case, wherein the case includes communications exchanged via a plurality of different communication channels;
extracting, based at least in part on the selection of the selectable element, interaction data representative of the communications from a plurality of different sources associated with the plurality of different communication channels;
inputting the interaction data into one or more models that are configured to process the interaction data and generate summarizations of content;
receiving, based at least in part on the interaction data and as output from the one or more models, the summarization, wherein the summarization identifies an issue associated with the case and a summary of at least one of the issue or the case; and
causing the summarization to be displayed via the user interface presented on the device.

9. The system as recited in claim 8, wherein the plurality of different communication channels include at least two of email messages, chat messages, text messages, audio calls, or messages exchanged via a website.

10. The system as recited in claim 8, wherein the one or more models include one or more generative artificial intelligence models or one or more large language models.

11. The system as recited in claim 8, wherein the operations further comprise:
receiving, from the device and via the user interface, an indication of an approval of the summarization; and
storing, based at least in part on the indication, the summarization in association with the case for subsequent access.

12. The system as recited in claim 8, wherein the operations further comprise:
causing display of a prompt template utilized to generate the summarization, wherein the prompt template includes one or more configurable characteristics;
receiving a modification to the one or more configurable characteristics, wherein the modification specifies at least one of the plurality of different communication channels or the plurality of different sources; and
causing the one or more models to generate the summarization based at least in part on the prompt template.

13. The system as recited in claim 8, wherein the issue is presented by a user, the communications are between the user and an agent that is assigned to resolve the issue, and the request is from a different agent that is unassociated with the communications.

14. The system as recited in claim 8, wherein the operations further comprise:
determining a resolution of the issue; and
generating the summarization to identify the resolution of the issue.

15. One or more non-transitory computer-readable media storing one or more computer-executable instructions that, when executed by one or more processors, cause the one or more processors to perform operations comprising:
receiving, from a device and via a user interface, a selection of a selectable element indicating a request to generate a summarization associated with a case, wherein the case includes communications exchanged via a plurality of different communication channels;
extracting, based at least in part on the selection of the selectable element, interaction data representative of the communications from a plurality of different sources associated with the plurality of different communication channels;
inputting the interaction data into one or more models that are configured to process the interaction data and generate summarizations of content;
receiving, based at least in part on the interaction data and as output from the one or more models, the summarization, wherein the summarization identifies an issue associated with the case and a summary of at least one of the issue or the case; and
causing the summarization to be displayed via the user interface presented on the device.

16. The one or more non-transitory computer-readable media as recited in claim 15, wherein the plurality of different communication channels include at least two of email messages, chat messages, text messages, audio calls, or messages exchanged via a website, and wherein the one or more models include one or more generative artificial intelligence models or one or more large language models.

17. The one or more non-transitory computer-readable media as recited in claim 15, wherein the operations further comprise:
receiving, from the device and via the user interface, an indication of an approval of the summarization; and
storing, based at least in part on the indication, the summarization in association with the case for subsequent access.

18. The one or more non-transitory computer-readable media as recited in claim 15, wherein the operations further comprise:
causing display of a prompt template utilized to generate the summarization, wherein the prompt template includes one or more configurable characteristics;
receiving a modification to the one or more configurable characteristics, wherein the modification specifies at least one of the plurality of different communication channels or the plurality of different sources; and
causing the one or more models to generate the summarization based at least in part on the prompt template.

19. The one or more non-transitory computer-readable media as recited in claim 15, wherein the issue is presented by a user, the communications are between the user and an agent that is assigned to resolve the issue, and the request is from a different agent that is unassociated with the communications.

20. The one or more non-transitory computer-readable media as recited in claim 15, wherein the operations further comprise:
determining a resolution of the issue; and
generating the summarization to identify the resolution of the issue.
